(19) United States
(12) Patent Application Publication
(10) Pub. No.: US 2025/0273059 A1
(43) Pub. Date: Aug. 28, 2025

(54) MULTI-MODE DOORBELL

(71) Applicant: SkyBell Technologies IP, LLC, Irvine, CA (US)

(72) Inventors: Joseph Frank SCALISI, Austin, TX (US); Tyler GILBRETH, Riverside, CA (US); Mark NOBLE, Anaheim, CA (US)

(21) Appl. No.: 19/062,705

(22) Filed: Feb. 25, 2025

Related U.S. Application Data
(60) Provisional application No. 63/558,071, filed on Feb. 26, 2024.

(51) Int. Cl. G08B 7/06; G06F 3/16; H04W 52/02

(52) U.S. Cl. CPC G08B 7/06; G06F 3/165; H04W 52/0248

(57) ABSTRACT

Included in the present disclosure is a system, including a chime. In some embodiments, the system includes a doorbell electrically coupled to the chime and configured to communicatively couple to a remote computing device, the doorbell spaced apart from the chime, and the doorbell comprising a vacancy mode and an access point (AP) mode. According to some embodiments, when the doorbell is in the vacancy mode, the doorbell is communicatively isolated from the remote computing device such that the doorbell is configured to send an alert by emitting a noise via the chime. When the doorbell is in the AP mode, the doorbell may be communicatively coupled to the remote computing device such that the doorbell is configured to send an alert to the remote computing device.

### CROSS-REFERENCE TO RELATED APPLICATIONS

The entire contents of the following application are incorporated by reference herein: U.S. Provisional Patent Application No. 63/558,071; filed on Feb. 26, 2024; and entitled MULTI-MODE DOORBELL.

### INTRODUCTION

### Technical Field

The present disclosure relates to doorbells. Specifically, the present disclosure relates to doorbells coupled with mechanical chimes and remote computing devices.

### Background

Most modern homes include a doorbell. In the past, traditional doorbells were installed for one reason, to indicate that someone is at the door and would like the resident's attention. These doorbells had a simple design with a single button, which, when pressed, would cause a chime to sound inside the home. In more recent years, the design and functionality of doorbells has changed to include doorbells that ring a certain tune or have cameras and/or microphones to allow residents to interact with the person at the door. These updated doorbells, known as “smart” doorbells, allow the resident to hear, see, and talk with visitors who approach a home (or other dwelling) and/or press the doorbell's button, even if the resident is not at home at the time of the visit. For example, security systems including doorbells can use a computing device, such as a resident's smartphone, to enable remote communication between the resident and the visitor. Doorbells also allow residents to remotely monitor their homes to guard against theft or other nefarious activities.

### SUMMARY

Included in the present disclosure is a system, including a chime. In some embodiments, the system includes a doorbell electrically coupled to the chime and configured to communicatively couple to a remote computing device and/or other communication-enabled device, the doorbell spaced apart from the chime, and the doorbell comprising a vacancy mode and an access point (AP) mode. According to some embodiments, when the doorbell is in the vacancy mode, the doorbell is communicatively isolated from the remote computing device and/or the communication-enabled device such that the doorbell is configured to send an alert by emitting a noise via the chime. When the doorbell is in the AP mode, the doorbell may be communicatively coupled to the remote computing device and/or communication-enabled device such that the doorbell is configured to send an alert to the remote computing device.

In some embodiments, when the doorbell is in the vacancy mode, the doorbell emits a light including a color. According to some embodiments, the color is configurable by a user of the doorbell. The color may be a first color, and when the doorbell is in the AP mode, the doorbell may include a second color, the second color different from the first color. In some embodiments, when the doorbell is in the AP mode, the doorbell includes a color.

According to some embodiments, the doorbell further includes a communications chip. The communications chip may be configured to communicate with the remote computing device. In some embodiments, the communications chip is configured to communicate via i) wireless fidelity (Wi-Fi), ii) Bluetooth, iii) cellular data, or iv) combinations thereof. According to some embodiments, the communications chip is configured to communicate with a hub independent of the remote computing device. The communications chip may be disabled when in the vacancy mode. In some embodiments, the communications chip is enabled when in the AP mode.

According to some embodiments, the doorbell includes an actuator. The doorbell may be configured to i) enter the AP mode from the vacancy mode through actuating the actuator, ii) enter the vacancy mode from the AP mode through actuating the actuator, or iii) both. In some embodiments, the doorbell is configured to i) enter the AP mode from the vacancy mode through actuating the actuator for a first predetermined amount of time, ii) enter the vacancy mode from the AP mode through actuating the actuator for a second predetermined amount of time, or iii) both. According to some embodiments, the first predetermined amount of time and the second predetermined amount of time are the same. The first predetermined amount of time and the second predetermined amount of time may be different.

In some embodiments, the doorbell is configured to enter the vacancy mode from the AP mode after a duration of time passes wherein the doorbell is not communicatively coupled to the remote computing device. According to some embodiments, the duration of time is about two weeks.

Entering the vacancy mode from the AP mode may isolate the doorbell from the remote computing device. In some embodiments, the doorbell is a first doorbell, and the system includes a second doorbell. According to some embodiments, i) the first doorbell, ii) the second doorbell, or iii) both are configured to enter the vacancy mode from the AP mode by an input from a master user.

The communications chip may be a first communications chip, and the doorbell may further include a second communications chip. In some embodiments, the second communications chip is configured to communicate with i) the chime, ii) the hub, or iii) both. According to some embodiments, the first communications chip is configured to communicate via Wi-Fi and the second communications chip is configured to communicate via Bluetooth. The first communications chip may be configured to enter hibernation mode when the doorbell is in the vacancy mode. In some embodiments, the second communications chip is configured to remain communicatively coupled to i) the chime, ii) the hub, or iii) both. According to some embodiments, when the first communications chip is in hibernation mode, the doorbell is unpaired with all remote computing devices. When the doorbell pairs with a remote computing device, the first communications chip may exit hibernation mode.

In some embodiments, the doorbell further includes a light emitting diode (LED). According to some embodiments, the doorbell further includes a night mode. When the doorbell is in the night mode, the LED may be configured to dim with respect to an ambient light level. In some embodiments, the doorbell further includes a day mode. According to some embodiments, when the doorbell is in the day mode, the LED is configured to brighten with respect to the ambient light level.

The doorbell may further include a sleep mode. In some embodiments, when the doorbell is in the sleep mode, the doorbell is communicatively coupled to the remote computing device, and the doorbell is configured to prevent the noise being emitted from the chime, a noise being emitted by the remote computing device, or both. According to some embodiments, when the doorbell is in the sleep mode, the doorbell prevents a circuit from completing, thereby preventing the noise being emitted from the chime.

When the doorbell is in the sleep mode, the doorbell may be configured to send the alert to the remote computing device without the remote computing device lighting up. In some embodiments, when the doorbell is in the sleep mode, the doorbell is configured to send the alert to the remote computing device without the remote computing device outputting haptic feedback. According to some embodiments, when the doorbell is in the sleep mode, the doorbell sends information to the remote computing device.

The doorbell may be configured to enter the sleep mode by an input from a user. In some embodiments, the doorbell is configured to enter the sleep mode at a predetermined time of day. According to some embodiments, the doorbell is configured to exit the sleep mode at a predetermined time of day. The doorbell may be configured to remain in the sleep mode for a predetermined duration.

In some embodiments, the doorbell further includes a non-auditory mode. According to some embodiments, when the doorbell is in the non-auditory mode, the doorbell is communicatively coupled to the remote computing device, and the doorbell is configured to prevent the noise being emitted from the chime and a noise being emitted from the remote computing device.

When the doorbell is in the non-auditory mode, the doorbell may prevent a circuit from completing, thereby preventing the noise being emitted from the chime. In some embodiments, when the doorbell is in the non-auditory mode, the doorbell prevents the remote computing device from making the noise. According to some embodiments, when the doorbell is in the non-auditory mode, the doorbell is configured to send the alert to the remote computing device while the remote computing device lights up. When the doorbell is in the non-auditory mode, the doorbell may be configured to send the alert to the remote computing device while the remote computing device outputs haptic feedback. In some embodiments, when the doorbell is in the non-auditory mode, the doorbell sends information to the remote computing device.

According to some embodiments, the doorbell is configured to enter the non-auditory mode by an input from a user. The doorbell may be configured to enter the non-auditory mode at a predetermined time of day. In some embodiments, the doorbell is configured to exit the non-auditory mode at a predetermined time of day. According to some embodiments, the doorbell is configured to remain in the non-auditory mode for a predetermined duration.

Also included in the present disclosure is a system, including a plurality of doorbells as provided in the preceding disclosure. In some embodiments, one or more doorbells are in AP mode and one or more doorbells are in vacancy mode. According to some embodiments, the remote computing device of the user is communicatively coupled to a single doorbell of the plurality of doorbells. The master user may have access to each of the plurality of doorbells.

Also included in the present disclosure is a method, including communicatively coupling a doorbell to a communication-enabled device, thereby placing the doorbell in an access point (AP) mode. In some embodiments, the doorbell is coupled to a chime spaced apart from the doorbell, such that the doorbell is configured to enable i) an alert to be received by a remote computing device, ii) a noise to be emitted by the chime, or iii) both, upon activation of the doorbell. According to some embodiments, the method includes communicatively isolating the doorbell from the communication-enabled device. The method may include placing the doorbell in a vacancy mode, wherein the doorbell remains coupled with the chime to enable the noise to be emitted therefrom via activation of the doorbell.

In some embodiments, the method further includes placing the doorbell in the AP mode from the vacancy mode by communicatively coupling the doorbell to i) the communication-enabled device, ii) another communication-enabled device, or iii) both. According to some embodiments, coupling the chime to the doorbell includes i) electrically coupling the chime to the doorbell, ii) communicatively coupling the chime to the doorbell, or iii) both. The method may further include electrically coupling the doorbell with the chime.

In some embodiments, the doorbell includes a communications chip. According to some embodiments, the method includes communicatively coupling the doorbell to the communication-enabled device via i) Wi-Fi, ii) Bluetooth, iii) cellular data, or iv) combinations thereof. The communications chip may be configured to communicatively couple the doorbell to a hub independent of the remote computing device via i) Wi-Fi, ii) Bluetooth, iii) cellular data, or iv) combinations thereof. In some embodiments, communicatively isolating the doorbell from the communication-enabled device includes disabling the communications chip.

According to some embodiments, communicatively isolating the doorbell from the communication-enabled device includes placing the communications chip in a hibernation mode. The hibernation mode may include providing a low amount of power to the communications chip to keep the communications chip on but unable to send out a communications signal.

In some embodiments, communicatively coupling the doorbell to the communication- enabled device includes enabling the communications chip. According to some embodiments, the communications chip is a first communications chip. The doorbell may include a second communications chip. In some embodiments, the method further includes communicatively coupling the chime to the doorbell via the second communications chip using i) Wi-Fi, ii) Bluetooth, iii) cellular data, or iv) combinations thereof.

According to some embodiments, the method further includes emitting a color from the doorbell while the doorbell is in the vacancy mode. The color may be a first color. In some embodiments, the method further includes emitting a second color from the doorbell while the doorbell is in the AP mode.

According to some embodiments, the doorbell includes an actuator. i) Placing the doorbell in the AP mode from the vacancy mode, ii) placing the doorbell in the vacancy mode from the AP mode, or iii) both may include actuating the actuator.

In some embodiments, i) placing the doorbell in the AP mode from the vacancy mode, ii) placing the doorbell in the vacancy mode from the AP mode, or iii) both includes actuating the actuator for a predetermined amount of time. According to some embodiments, placing the doorbell in the AP mode from the vacancy mode includes actuating the actuator for a first predetermined amount of time. Placing the doorbell in the vacancy mode from the AP mode may include actuating the actuator for a second predetermined amount of time that is different from the first predetermined amount of time. In some embodiments, the method further includes placing the doorbell in the vacancy mode from the AP mode after a duration of time passes in which the doorbell is not communicatively coupled to the communication-enabled device.

According to some embodiments, the doorbell includes a light emitting diode (LED). The method may further include placing the doorbell in a night mode. In some embodiments, the method further includes dimming the LED, while in the night mode, with respect to an ambient light level. According to some embodiments, the method further includes placing the doorbell in a day mode. The method may further include brightening the LED, while in the day mode, with respect to an ambient light level.

In some embodiments, the method further includes placing the doorbell in a sleep mode. According to some embodiments, the method further includes preventing the chime, while the doorbell is in the sleep mode, from emitting the noise. The method may further include preventing the remote computing device, while the doorbell is in the sleep mode, from emitting a noise.

In some embodiments, preventing the chime from emitting the noise includes preventing a circuit from completing. According to some embodiments, the method further includes sending the alert to the remote computing device. The method may further include preventing the remote computing device from lighting up.

In some embodiments, the method further includes sending the alert to the remote computing device. According to some embodiments, the method further includes preventing the remote computing device from outputting haptic feedback. The method may further include sending information to the remote computing device.

In some embodiments, placing the doorbell in the sleep mode includes receiving input by a user. According to some embodiments, placing the doorbell in the sleep mode may include entering the sleep mode at a predetermined time of day. The method may further include keeping the doorbell in a sleep mode for a predetermined amount of time. In some embodiments, the method further includes exiting the sleep mode. According to some embodiments, exiting the sleep mode includes exiting the sleep mode at a predetermined time of day.

The method may further include placing the doorbell in a non-auditory mode. In some embodiments, the method further includes preventing the chime, while the doorbell is in the non-auditory mode and activated, from emitting a noise. According to some embodiments, the method further includes preventing the remote computing device, while the doorbell is in the non-auditory mode and activated, from emitting a noise due to the alert.

Preventing the chime from emitting the noise may include preventing a circuit from completing. In some embodiments, the method further includes sending the alert to the remote computing device. According to some embodiments, the method further includes permitting the remote computing device to light up.

The method may further include sending the alert to the remote computing device. In some embodiments, the method further includes permitting the remote computing device to output haptic feedback. According to some embodiments, the method further includes sending information to the remote computing device.

Placing the doorbell in the non-auditory mode may include receiving input by a user. In some embodiments, placing the doorbell in the non-auditory mode includes entering the non-auditory mode at a predetermined time of day. According to some embodiments, the method further includes keeping the doorbell in a non-auditory mode for a predetermined amount of time. The method may further include exiting the non-auditory mode. In some embodiments, exiting the non-auditory mode includes exiting the non-auditory mode at a predetermined time of day.

Also included in the present disclosure is a non-transitory, computer-readable media, executable by a processor, and configured to cause the processor to perform the step of communicatively coupling a doorbell to a communication-enabled device, thereby placing the doorbell in an access point (AP) mode. In some embodiments, the doorbell is coupled to a chime spaced apart from the doorbell, such that the doorbell is configured to enable i) an alert to be received by a remote computing device, ii) a noise to be emitted by the chime, or iii) both, upon activation of the doorbell. According to some embodiments, the non-transitory, computer-readable media is configured to cause the processor to perform the step of communicatively isolating the doorbell from the communication-enabled device. The non-transitory, computer-readable media may be configured to cause the processor to perform the step of placing the doorbell in a vacancy mode, wherein the doorbell remains coupled with the chime to enable the noise to be emitted therefrom via activation of the doorbell.

In some embodiments, the non-transitory, computer-readable media is further configured to cause the processor to perform the step of placing the doorbell in the AP mode from the vacancy mode by communicatively coupling the doorbell to i) the communication-enabled device, ii) another communication-enabled device, or iii) both. According to some embodiments, coupling the chime to the doorbell includes i) electrically coupling the chime to the doorbell, ii) communicatively coupling the chime to the doorbell, or iii) both. The non-transitory, computer-readable media may be further configured to cause the processor to perform the step of electrically coupling the doorbell with the chime.

In some embodiments, the doorbell includes a communications chip, and wherein communicatively coupling the doorbell to the communication-enabled device via i) Wi-Fi, ii) Bluetooth, iii) cellular data, or iv) combinations thereof. According to some embodiments, the communications chip is configured to communicatively couple the doorbell to a hub independent of the remote computing device via i) Wi-Fi, ii) Bluetooth, iii) cellular data, or iv) combinations thereof.

Communicatively isolating the doorbell from the communication-enabled device may include disabling the communications chip. In some embodiments, communicatively isolating the doorbell from the communication-enabled device includes placing the communications chip in a hibernation mode. According to some embodiments, the hibernation mode includes providing a low amount of power to the communications chip to keep the communications chip on but unable to send out a communications signal. Communicatively coupling the doorbell to the communication-enabled device may include enabling the communications chip.

In some embodiments, the communications chip is a first communications chip. According to some embodiments, the doorbell includes a second communications chip. The non-transitory, computer-readable media may be further configured to cause the processor to perform the step of communicatively coupling the chime to the doorbell via the second communications chip using i) Wi-Fi, ii) Bluetooth, iii) cellular data, or iv) combinations thereof.

In some embodiments, the non-transitory, computer-readable media is further configured to cause the processor to perform the step of emitting a color from the doorbell while the doorbell is in the vacancy mode. According to some embodiments, the color is a first color. The non-transitory, computer-readable media may be further configured to cause the processor to perform the step of emitting a second color from the doorbell while the doorbell is in the AP mode.

In some embodiments, the doorbell includes an actuator. According to some embodiments, i) placing the doorbell in the AP mode from the vacancy mode, ii) placing the doorbell in the vacancy mode from the AP mode, or iii) both includes actuating the actuator. i) Placing the doorbell in the AP mode from the vacancy mode, ii) placing the doorbell in the vacancy mode from the AP mode, or iii) both may include actuating the actuator for a predetermined amount of time. In some embodiments, placing the doorbell in the AP mode from the vacancy mode includes actuating the actuator for a first predetermined amount of time. According to some embodiments, placing the doorbell in the vacancy mode from the AP mode includes actuating the actuator for a second predetermined amount of time that is different from the first predetermined amount of time.

The non-transitory, computer-readable media may be further configured to cause the processor to perform the step of placing the doorbell in the vacancy mode from the AP mode after a duration of time passes in which the doorbell is not communicatively coupled to the communication-enabled device.

In some embodiments, the doorbell includes a light emitting diode (LED). According to some embodiments, the non-transitory, computer-readable media is further configured to cause the processor to perform the step of placing the doorbell in a night mode. The non-transitory, computer-readable media may be further configured to cause the processor to perform the step of dimming the LED, while in the night mode, with respect to an ambient light level. In some embodiments, the non-transitory, computer-readable media is further configured to cause the processor to perform the step of placing the doorbell in a day mode. According to some embodiments, the non-transitory, computer-readable media is further configured to cause the processor to perform the step of brightening the LED, while in the day mode, with respect to an ambient light level.

The non-transitory, computer-readable media is further configured to cause the processor to perform the step of placing the doorbell in a sleep mode. In some embodiments, the non-transitory, computer-readable media is further configured to cause the processor to perform the step of preventing the chime, while the doorbell is in the sleep mode, from emitting the noise. According to some embodiments, the non-transitory, computer-readable media is further configured to cause the processor to perform the step of preventing the remote computing device, while the doorbell is in the sleep mode, from emitting a noise.

Preventing the chime from emitting the noise may include preventing a circuit from completing. In some embodiments, the non-transitory, computer-readable media is further configured to cause the processor to perform the step of sending the alert to the remote computing device. According to some embodiments, the non-transitory, computer-readable media is further configured to cause the processor to perform the step of preventing the remote computing device from lighting up. The non-transitory, computer-readable media may be further configured to cause the processor to perform the step of sending the alert to the remote computing device. In some embodiments, the non-transitory, computer-readable media is further configured to cause the processor to perform the step of preventing the remote computing device from outputting haptic feedback. According to some embodiments, the non-transitory, computer-readable media is further configured to cause the processor to perform the step of sending information to the remote computing device.

Placing the doorbell in the sleep mode may include receiving input by a user. In some embodiments, placing the doorbell in the sleep mode includes entering the sleep mode at a predetermined time of day. According to some embodiments, the non-transitory, computer-readable media is further configured to cause the processor to perform the step of keeping the doorbell in a sleep mode for a predetermined amount of time. The non-transitory, computer-readable media may be further configured to cause the processor to perform the step of exiting the sleep mode. In some embodiments, exiting the sleep mode includes exiting the sleep mode at a predetermined time of day.

According to some embodiments, the non-transitory, computer-readable media is further configured to cause the processor to perform the step of placing the doorbell in a non-auditory mode. The non-transitory, computer-readable media may be further configured to cause the processor to perform the step of preventing the chime, while the doorbell is in the non-auditory mode and activated, from emitting a noise. In some embodiments, the non-transitory, computer-readable media is further configured to cause the processor to perform the step of preventing the remote computing device, while the doorbell is in the non-auditory mode and activated, from emitting a noise due to the alert.

According to some embodiments, preventing the chime from emitting the noise includes preventing a circuit from completing. The non-transitory, computer-readable media may be further configured to cause the processor to perform the step of sending the alert to the remote computing device. In some embodiments, the non-transitory, computer-readable media is further configured to cause the processor to perform the step of permitting the remote computing device to light up. According to some embodiments, the non-transitory, computer-readable media is further configured to cause the processor to perform the step of sending the alert to the remote computing device. The non-transitory, computer-readable media may be further configured to cause the processor to perform the step of permitting the remote computing device to output haptic feedback. In some embodiments, the non-transitory, computer-readable media is further configured to cause the processor to perform the step of sending information to the remote computing device.

According to some embodiments, placing the doorbell in the non-auditory mode includes receiving input by a user. Placing the doorbell in the non-auditory mode may include entering the non-auditory mode at a predetermined time of day. In some embodiments, the non-transitory, computer-readable media is further configured to cause the processor to perform the step of keeping the doorbell in a non-auditory mode for a predetermined amount of time. According to some embodiments, the non-transitory, computer-readable media is further configured to cause the processor to perform the step of exiting the non-auditory mode. Exiting the non-auditory mode may include exiting the non-auditory mode at a predetermined time of day

The foregoing, and other features and advantages of the invention, will be apparent from the following, more particular description of the preferred embodiments of the invention, the accompanying drawings, and the claims.

### BRIEF DESCRIPTION OF DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a perspective view of a series of doorbells in a building, according to some embodiments.

FIG. 2 illustrates a view of a doorbell system, according to some embodiments.

FIG. 3 illustrates a view of a doorbell, according to some embodiments.

FIG. 4 illustrates a block diagram of communication between elements of the doorbell system, according to some embodiments.

FIG. 5 illustrates a block diagram of a communication system, according to some embodiments.

FIG. 6 illustrates a flowchart depicting a method of permitting a doorbell to automatically enter a vacancy mode from an access point (AP) mode, according to some embodiments.

FIG. 7 illustrates a flowchart depicting another method of placing a doorbell in a vacancy mode, according to some embodiments.

FIG. 8 illustrates a flowchart depicting another method of placing a doorbell in a vacancy mode from an AP mode, according to some embodiments.

FIG. 9 illustrates a flowchart depicting a method of placing a doorbell in an AP mode from a vacancy mode, according to some embodiments.

FIG. 10 illustrates a flowchart depicting a method of placing a doorbell in an AP mode and in a vacancy mode, according to some embodiments.

FIG. 11 illustrates a flowchart depicting another method of placing the doorbell in the AP mode from the vacancy mode, according to some embodiments.

FIG. 12 illustrates a flow chart depicting a method of various light emissions from the doorbell, according to some embodiments.

FIG. 13 illustrates a flow chart depicting a method of placing the doorbell in a sleep mode, according to some embodiments.

FIG. 14 illustrates a method of placing the doorbell in a non-auditory mode, according to some embodiments.

### DETAILED DESCRIPTION OF THE INVENTION

There may be some situations where the features of a doorbell, such as two-way communication, are not required or wanted, but the basic ability to press a button and sound a chime is still desired. For example, multi-unit dwellings, such as apartment buildings, may include doorbells at each unit, but some residents may not want to use the two-way communication functionality of the doorbell, such as a resident communicating through their mobile computing device (e.g., smartphone) to a visitor located adjacent to their doorbell. In addition, an apartment building may have one or more empty units without residents to use or pay for the advanced features of the doorbell. In such situations, it may be desirable to place a doorbell into an operation mode that effectively turns off the advanced features, but still allows visitors to press a button and sound a chime.

Further, if an apartment building is under construction and nearing completion, but not yet occupied by residents, it may be desirable for the contractors to place the doorbells at each unit into the aforementioned operation mode. Because the doorbells can still perform the basic function of sounding a chime when the button is pressed, this operation mode may allow the building to pass inspection requirements without requiring a connection to a Wi-Fi router or access point (AP). In addition, doorbells in the operation mode may not emit a flashing light that is common amongst doorbells not connected to a Wi-Fi network, which may also help the building pass inspection. Then, once residents move into the building, they can decide if they want to keep their unit's doorbell in the operation mode, considered a “vacancy mode” that only activates the doorbell's chime, or activate an “AP Mode” having advanced features, such as two-way communication. Having doorbells that are able to operate in a vacancy mode and an AP Mode will allow buildings to better pass inspection. Additionally, having doorbells already installed and ready to activate may be an attractive feature to prospective tech-savvy residents, while the ability to keep the doorbells limited to more basic functions may be attractive to other residents who don't want the advanced features of the doorbell.

The present disclosure describes a doorbell system with a doorbell configured to operate in multiple different modes or states. In some embodiments, the doorbell operates in a first mode that functions as a simple mechanical doorbell; this mode may be referred to as vacancy mode. The doorbell may also operate in a second mode that allows two-way communication between a resident and a visitor at the doorbell; this mode may be referred to as AP Mode.

The doorbell may transition between modes manually or automatically. In some embodiments, to manually transition between the vacancy mode and the AP Mode, a resident presses and holds a button on the doorbell for a predetermined amount of time and releases the button press, which thereby causes the doorbell to transition from the first mode (vacancy mode) to the second mode (AP Mode). In some embodiments, to manually transition between the AP Mode and the vacancy mode, a resident presses and holds the button on the doorbell for a predetermined amount of time and releases the button press, which thereby causes the doorbell to transition from the second mode (AP Mode) to the first mode (vacancy mode).

In some embodiments, when the doorbell is not connected to a wireless network, the doorbell attempts to automatically transition between modes; in this regard, the doorbell searches for a connection to a wireless network, such as a Wi-Fi network. However, if the doorbell does not connect to a network, the doorbell may be configured to restart and search for a connection again. This process may be repeated a predetermined number of times or for a predetermined amount of time before the doorbell automatically transitions from the AP Mode to the vacancy mode.

Changing the doorbell between modes may be done for a number of reasons. In some embodiments, the resident is not interested in the features of one mode or if they move out of the residence and do not want the new residents to use the connected application or account of the previous residents.

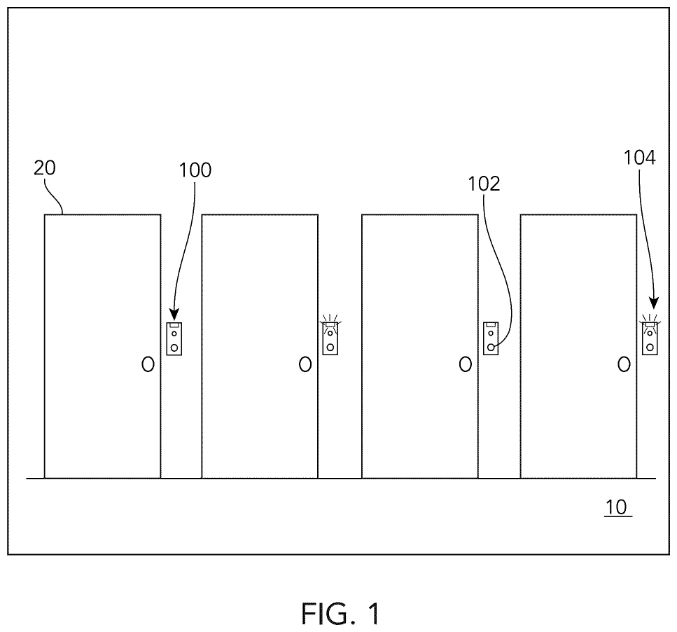

FIG. 1 illustrates a series of doors 20 located within a building 10. Adjacent to each door 20 is a doorbell 100. In some examples, each doorbell 100 includes a button 102 and a light 104. The light 104 may be configured to emit any color and/or combination of colors. In some examples, the light 104 is used to indicate actions or states of the doorbell 100, such as what mode (i.e., vacancy mode or AP Mode) the doorbell 100 is operating in and/or whether the button 102 of the doorbell 100 has been fully pressed. According to some examples, the button 102 is pressed to ring the doorbell 100 and/or otherwise indicate that a person is at the door 20.

As demonstrated in FIG. 1, the light 104 may be configured to flash or blink. In some examples, the light 104 blinks when the doorbell 100 is in AP Mode and is searching for a wireless connection, such as a Wi-Fi network connection. According to some examples, the light 104 stops blinking and/or does not blink when the doorbell 100 is connected to a wireless connection. The light 104 may stop blinking and/or does not blink when the doorbell 100 is in the vacancy mode, which does not include searching for a wireless connection. The doorbells 100 shown in FIG. 1 may transition from one mode to the other and back.

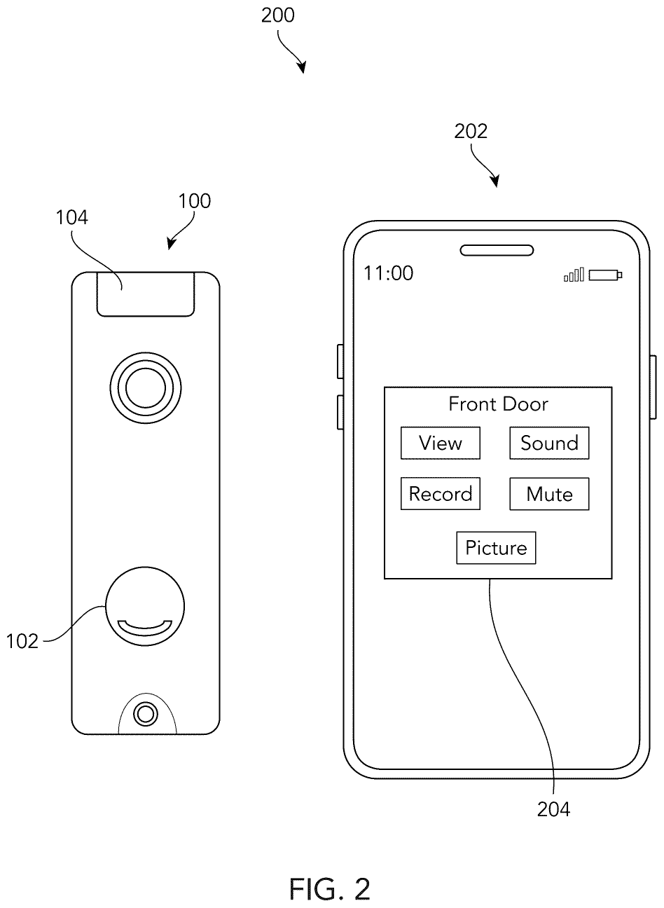

FIG. 2 illustrates a doorbell system 200, according to some embodiments. The doorbell system 200 may include the doorbell 100 and a computing device 202, as shown in FIG. 2. The computing device 202 is shown running software. In some examples, a user can log into an “app,” website, and/or software on the computing device 202 (e.g., mobile computing device, smartphone, tablet, and/or desktop computer) to adjust the doorbell 100 settings discussed herein. Some embodiments include computer software (e.g., application software), which can be a mobile application designed to run on smartphones, tablet computers, and other mobile devices. Software of this nature is sometimes referred to as “app” software. Some embodiments include software designed to run on desktop computers and laptop computers.

The computing device 202 may be configured to run software with a graphical user interface 204. The user interface 204 may include icons or buttons, as illustrated in FIG. 2. In some examples, the software is configured for use with a touch-screen computing device 202 such as a smartphone or tablet. The user interface 204 may also include an indication of the location of the doorbell 100 that the user interface 204 is displaying. For example, FIG. 2 shows the user interface 204 featuring the words “Front Door,” indicating that the doorbell 100 is located at the front door of the residence. Accordingly, a person can use one computing device 202 to control and/or interact with multiple doorbells 100, such as one doorbell 100 located at a front door and another doorbell 100 located at a back door, guesthouse, or the like.

The user interface 204 can include a connectivity indicator. In some embodiments, the connectivity indicator can indicate whether the computing device 202 is in communication with the doorbell 100, the internet, and/or a cellular network. The connectivity indicator can alert the user if the computing device 202 has lost its connection with the doorbell 100; if the doorbell 100 has been damaged; if the doorbell 100 has been stolen; if the doorbell 100 has been removed from its mounting location; if the doorbell 100 lost electrical power; and/or if the computing device 202 cannot communicate with the doorbell 100. In some embodiments, the connectivity indicator alerts the user of the computing device 202 by flashing, emitting a sound, displaying a message, and/or displaying a symbol.

In some examples, the computing device 202 can enable a user to watch live video and/or hear live audio from the doorbell 100 due to the user's request rather than due to the actions of a visitor. Some examples include the user initiating a live video feed (or a video feed that is less than five minutes old) the computing device 202. In some examples, live video and/or audio are initiated by the visitor pressing the button 102 on the doorbell 100. Video can be sent to and/or received from the computing device 202 using video chat protocols such as FaceTime (by Apple Inc.) or Skype (by Microsoft Corporation). In some examples, these videos are played by videoconferencing apps on the computing device 202 instead of being played by the user interface 204.

In some examples, the user interface 204 displays an image such as a still image or a video of an area near and/or in front of the doorbell 100. The user may navigate to the live view of the field of view of the doorbell 100 by pressing the “View” button of the user interface 204. An image of the field of view can be taken by a camera of the doorbell 100 and stored by the doorbell 100, the computing device 202, and/or a third-party device, such as a server or the Cloud. The user interface can include a “Record” button, as shown in FIG. 2, to enable a user to record images, videos, and/or sound from the doorbell 100 and/or the computing device 202.

The user interface 204 may include a “Picture” button, as illustrated in FIG. 2, to allow the user to take still pictures and/or videos of the area near and/or in front of the doorbell 100. In some examples, user can capture a short video (e.g., less than five seconds, less than 10 seconds) of the area near and/or in front of the doorbell 100. The image and/or short video is stored in the computing device 202 and/or in a remote location and is retrievable by the computing device 202.

The user interface 204 can also include a “Sound” button, to adjust sound levels, and a “Mute” button, both of which are shown in FIG. 2. The user interface 204 may also include camera manipulation buttons such as zoom, pan, and light adjustment buttons. In some examples, the camera automatically adjusts between Day Mode and Night Mode based on ambient light levels. Some examples include an infrared camera and/or infrared lights to illuminate an area near the doorbell 100 to enable the camera to provide sufficient visibility, even at night.

In some examples, the user interface 204 includes a quality selection button, which can allow a user to select the quality and/or amount of the data transmitted from the doorbell 100 to the computing device 202 and/or from the computing device 202 to the doorbell 100. For example, if the data transmission capability of wireless communication is insufficient to transmit high-resolution video from the doorbell 100 to the computing device 202, the user might select a lower-resolution video setting. In some cases, the user might select a still image rather than a video or a single still image every period of time where the period of time can be more than 0.1 seconds and/or less than 60 seconds; more than 0.5 seconds and/or less than 30 seconds; or more than 1 second and/or less than 15 seconds. In some cases, the doorbell 100 might only send a single still image to the computing device 202.

In some examples, the user interface 204 has a button to make the doorbell ring (e.g., make the chime emit a sound inside of the building 10). Accordingly, the user may ring the doorbell 100 by pressing a button on the computing device 202.

The user interface 204 can include a termination button to end communication between the doorbell 100 and the computing device 202. In some examples, the termination button ends the ability of the person located near the doorbell 100 (i.e., the visitor) to hear and/or see the user of the computing device 202, but does not end the ability of the user of the computing device 202 to hear and/or see the person located near the doorbell 100.

In some examples, a button of the user interface 204 is both an answer button (to accept a communication request from a visitor) and a termination button (to end communication between the doorbell 100 and the computing device 202). The button can include the word “Answer” when the doorbell system 200 is attempting to establish two-way communication between the visitor and the user. Selecting the button when the doorbell system 200 is attempting to establish two-way communication between the visitor and the user can start two-way communication. The button can include the words “End Call” during a two-way communication session between the visitor and the user. Selecting the button during a two-way communication session can terminate two-way communication. In some examples, terminating two-way communication still enables the user to see and hear the visitor. In some examples, terminating two-way communication causes the computing device 202 to stop showing video from the doorbell 100 and to stop emitting sounds recorded by the doorbell 100.

In some examples, the user interface 204 opens as soon as the doorbell 100 detects a visitor (e.g., senses indications of a visitor). Detecting the visitor can include detecting a press of the button 102 and/or other indications, such as motion of the visitor. Once the user interface 204 opens, the user can see and/or hear the visitor even before “answering” or otherwise accepting two-way communication. In some examples, software of the doorbell system 200 includes means to start the video feed on demand. A user of the computing device 202 might wonder what is happening near the doorbell 100. The user can open the software application on the computing device 202 and instruct the application to show live video and/or audio from the doorbell 100 even if no event near the doorbell 100 has triggered the communication.

In some examples, software, the computing device 202, and/or the user interface 204 enables a user to control the features and functions of the doorbell 100. In some examples, the software, the computing device 202, and/or the user interface 204 enables a user to turn the doorbell 100 off and/or turn the ringing function off such that pressing the doorbell button 102 will not emit a sound, such as a chime, inside the building 10. Example chimes include sounds emitted from door chimes made by HeathCo LLC under the brand Heath Zenith. Turning the doorbell 100 off and/or turning the ringing function off can be helpful when the user does not want people inside the building 10 to be bothered by doorbell sounds (e.g., chimes), such as at night when people might be sleeping inside the home.

The user interface 204 can include a button to silence the doorbell sound and to place the doorbell 100 in a Silent Mode. In some examples of Silent Mode, pressing the doorbell button 102 will not send a signal to a chime located inside the building 10 for the chime to emit a sound. In some examples, the chime is a speaker (such as a speaker made by Bose Corporation) located inside of the building 10, which can be a home, office, warehouse, or other structure.

In some examples, the term “button” includes diverse means of selecting various options, features, and functions. Buttons can be selected by mouse clicks, keyboard commands, and touching a touch screen. Many embodiments of the doorbell 100 include buttons that can be selected without touch screens.

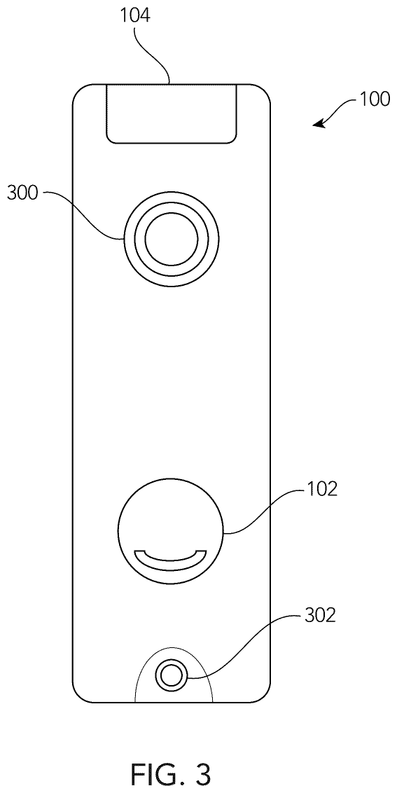

Turning now to FIG. 3, a more detailed view of the doorbell 100 is shown. As illustrated, the doorbell 100 may include the button 102, the light 104, a camera 300, and a motion detector 302. As previously mentioned, the button 102 may be pressed to ring the doorbell 100 and/or otherwise indicate that a person is at the door 20. The light 104 may be configured to illuminate to indicate a number of circumstances, such as whether the button 102 has been pressed or the operating mode of the doorbell 100. As discussed with reference to FIG. 1, the light 104 may be configured to blink or flash when the doorbell 100 is in AP Mode and searching for a wireless connection. In some examples, the doorbell 100 includes more than one light 104. The light 104 may be located on the doorbell 100 along a top portion, as shown in FIG. 3, or along any other portion (e.g., sides, bottom, or front) of the doorbell 100.

The camera 300 may be used to visually indicate and/or view a person and/or object at the door 20. In some examples, the motion detector 302 is used to detect a presence of a visitor, an animal, an intruder, and the like. The motion detector 302 may also be used to automatically turn on the camera 300 and/or ring the doorbell 100 when motion is detected. In some examples, the doorbell 100 can be configured to record when the doorbell 100 detects movement and/or the presence of a person. The user of the computing device 202 can later review all video and/or audio records captured when the doorbell 100 detected movement and/or the presence of a person.

Some examples include using facial recognition such that the camera 300 waits until the camera 300 has a good view of the person located near the doorbell 100 and then captures an image of the person's face. Facial recognition can be used to establish a visitor's identity. The doorbell system 200 may include a database of recognized visitors determined by facial recognition data.

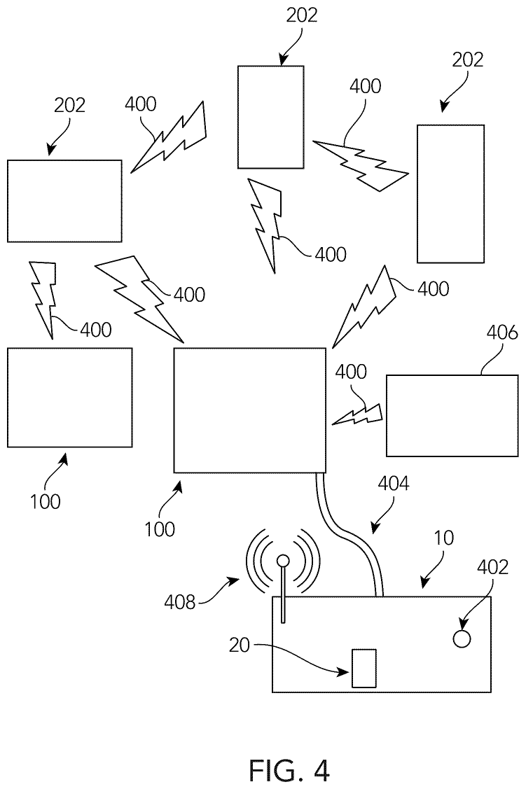

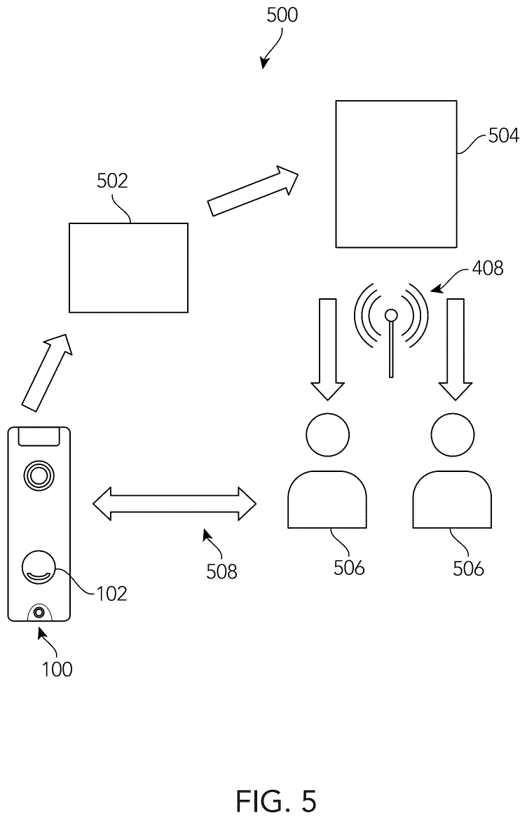

The doorbell 100 may also include additional components, including, but not limited to, a microphone and a speaker. In some embodiments, the microphone and speaker may be used to facilitate communication between the doorbell 100 and a person such as a visitor, an emergency dispatcher, and an emergency contact. Communication capabilities of the system 200 will be discussed further with reference to FIGS. 4 and 5.

FIG. 4 illustrates a block diagram showing an embodiment in which the doorbell 100 is connected to a building 10, which can include a door 20. Electrical wires 404 can electrically couple the doorbell 100 to the electrical system of the building 10 such that the doorbell 100 can receive electrical power from the building 10. It should be noted that the doorbell 100 may receive power from a battery rather than the building 10. FIG. 4 also shows a chime 402 coupled to the building 10. In some examples, the chime 402 is located within the building 10 and is configured to emit a noise when the button 102 of the doorbell 100 is pressed.

In some examples, a wireless network 408 allows devices, such as the doorbell 100, to wirelessly access the internet. The wireless network 408 can transmit data from the doorbell 100 to the internet, which can transmit the data to one or more remotely located computing devices 202. The internet and wireless networks 408 can transmit data from the remotely located computing device(s) 202 to the doorbell 100. In some embodiments, the doorbell 100 connects to a home's Wi-Fi network to access the internet.

FIG. 4 also includes several lightning bolt icons representing wireless communication 400 between elements shown in FIG. 4. Wireless communication 400 can enable the doorbell 100 to communicate with the computing device 202. Some examples enable communication via a wireless network 408, such as a cellular and/or Wi-Fi network. Some examples enable communication via the Internet. The wireless communication 400 can include the following communication means: radio, Wi-Fi (e.g., wireless local area network), cellular, Internet, Bluetooth, telecommunication, electromagnetic, infrared, light, sonic, and/or microwave. Other communication means are used by some embodiments of the doorbell system 200. In some examples, such as examples that include telecommunication or cellular communication means, the doorbell 100 initiates voice calls or sends text messages to a computing device 202. In some examples, the doorbell 100 and the computing device 202 are configured to communicate via wired, rather than wireless, communication.

As illustrated in FIG. 4, one computing device 202 (e.g., a laptop, a smartphone, a mobile computing device, and/or a television 406) can communicate with multiple doorbells 100. In some examples, multiple computing devices 202 can communicate with one doorbell 100.

In some examples, the doorbell 100 communicates (e.g., via wireless communication 400) with a television 406, which can be a smart television. The television 406 may be configured to display any of the items that can be displayed on the user interface 204 of the computing device 202, such as application features, a view of the field of view of the doorbell 100, and input buttons. In some examples, users of the doorbell 100 are able to use the television 406 to see and/or speak with a visitor.

FIG. 5 illustrates a block diagram of a communication system 500, according to some examples. FIG. 5 shows the doorbell 100 in two-way communication 508 with at least one user 506. In some examples, the doorbell 100 is in two-way communication 508 via a computing device 202 of that at least one user 506. As previously discussed, two-way communication may enable the at least one user 506 to interact with a visitor located at the doorbell 100, even if the user 506 is away from the home. In some examples, two-way communication 508 includes at least one of video and audio communication.

FIG. 5 also illustrates the doorbell 100 in communication with a Wi-Fi router 502 (e.g., to access the internet), which is further in communication with a server 504. The server 504 may be in communication with at least one user 506, such as through a wireless network 408. The server 504 may also be in communication with at least one user 506 via the user's computing device 202. In some examples, the server 504 can initiate communication with the computing device 202 and/or to the doorbell 100. The server 504 may initiate, control, and/or block communication between the computing device 202 and the doorbell 100. As discussed previously in this disclosure, images, including videos, captured by the doorbell 100 may be stored on the doorbell 100, the computing device 202, and/or a server 504. Enabling communication between the server 504 and the computing device 202 may allow users to review stored images from past dates.

In some examples, if the doorbell 100 loses power, loses connectivity to the computing device 202, loses connectivity to the Internet, such as through the Wi-Fi router 502, and/or loses connectivity to the server 504, which may be a remote server, the server 504 sends an alert (e.g., phone call, text message, image on the user interface 204) regarding the power and/or connectivity issue. In some examples, the server 504 manages communication between the doorbell 100 and the computing device 202. Information from the doorbell 100 may be stored by the server 504. In some examples, information from the doorbell 100 is stored by the server 504 until the information can be sent to the computing device 202, uploaded to the computing device 202, and/or displayed to the remotely located person via the computing device 202. The server 504 can be a computing device 202 that stores information from the doorbell 100 and/or from the computing device 202. In some examples, the server 504 is located in a data center.

In some examples, the computing device 202 and/or the server 504 attempts to communicate with the doorbell 100. If the computing device 202 and/or the server 504 is unable to communicate with the doorbell 100, the computing device 202 and/or the server 504 may alert the remotely located user 506 via the software, phone, text, a displayed message, and/or a website. In some examples, the computing device 202 and/or the server 504 attempts to communicate with the doorbell 100 periodically; at least every five hours and/or less than every 10 minutes; at least every 24 hours and/or less than every 60 minutes; or at least every hour and/or less than every second.

In some examples, an image and/or video of each visitor is automatically stored in a visitor log retrievable by the user 506. The image and/or video of each visitor can be automatically triggered by the doorbell 100 detecting a visitor.

Data sent between the doorbell 100 and the computing device 202 can be secured via encryption, transport layer security, secure sockets layer, and/or cryptographic protocols. Data regarding a doorbell 100 that is sent from one computing device 202 to another computing device 202 can be secured via encryption, transport layer security, secure sockets layer, and/or cryptographic protocols.

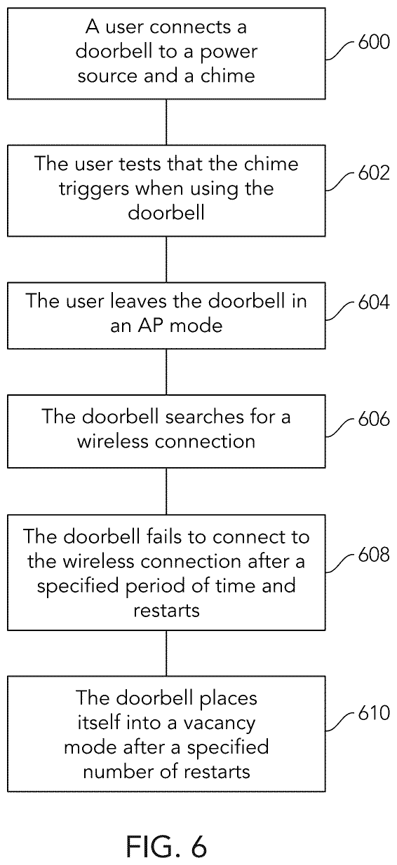

FIG. 6 illustrates a process flowchart, according to some embodiments. This figure shows a series of steps that may be used when the doorbell 100 is installed. In some examples, a user 506 connects the doorbell 100 to a power source and a chime, at Step 600. The power source may be a wired power source and/or a battery power source. This power source may come from a doorbell circuit. According to some examples, the user 506 will ensure that the doorbell 100 triggers a chime when the button 102 of the doorbell 100 is pressed, at Step 602. These steps may occur while the doorbell 100 is in the AP Mode or the vacancy mode.

In some examples, the user 506 will install the doorbell 100 in the AP Mode but not sync the doorbell 100 to a wireless network 408, at Step 604. The doorbell 100 may search for a wireless network 408, at Step 606. According to some examples, leaving the doorbell 100 in the AP Mode but the doorbell 100 not syncing to a wireless network 408 results in software in the doorbell system 200 telling the doorbell 100 to restart after a period of time, at Step 608. This period of time may be one hour. In some examples, the restarting of the doorbell 100 is part of a systems check and/or is a firmware fallback. According to some examples, the doorbell 100 will restart a certain number of times before the doorbell 100 transitions into the vacancy mode, at Step 610. The number of times may be around 345. In some examples, the light 104 on the doorbell 100 will be a solid cyan color when the doorbell 100 is in the vacancy mode.

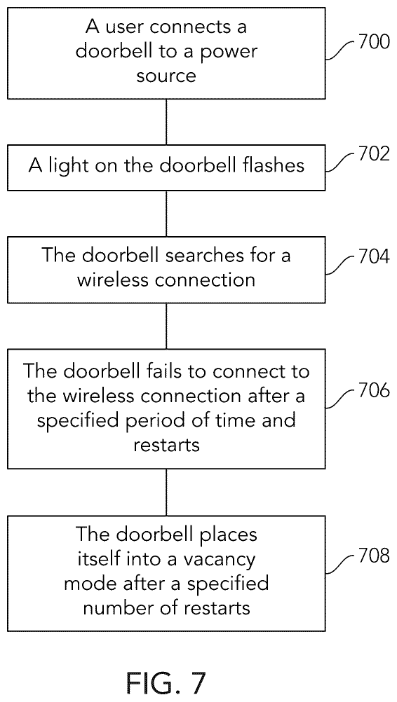

FIG. 7 illustrates a process flowchart, according to some embodiments. This figure shows a series of steps that may be used when the doorbell 100 is in the AP Mode and the doorbell 100 is connected to a wireless network 408. In some examples, the doorbell 100 becomes disconnected from the wireless network 408 but a user still connects the doorbell to the power source, at Step 700. This may be due to the user disconnecting the wireless network 408 and/or moving to a new home. According to some examples, the doorbell 100 will provide an indication, such as a noise or a light 104 on the doorbell 100 flashing, that it is not connected to a wireless network 408, at Step 702. The light 104 may be an orange flashing LED to indicate that the doorbell 100 is seeking the last known wireless network 408. The lack of connection to a wireless network 408 may result in the doorbell 100 attempting to connect to the same wireless network 408 or to search for another wireless network 408, at Step 704. Similar to the flowchart of FIG. 6, the software in the doorbell system 200 may tell the doorbell 100 to restart after a period of time, at Step 706, and the doorbell 100 will continue the cycle of searching for a wireless network 408 and restarting a certain number of times before the doorbell 100 places itself into the vacancy mode, at Step 708. In some examples, the restarting of the doorbell 100 is part of a systems check and/or is a firmware fallback.

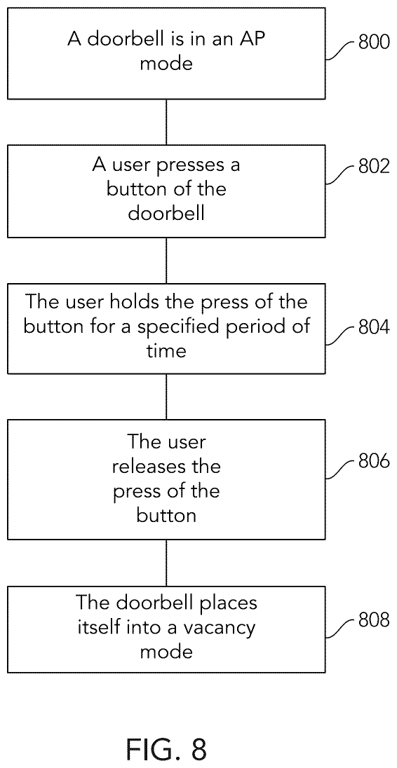

FIG. 8 illustrates a process flowchart, according to some embodiments. This figure shows a series of steps that may be used when the doorbell 100 is in the AP Mode, at Step 800. In some examples, the user 506 wants to put the doorbell 100 into the vacancy mode. In some examples, this change of modes is done manually. According to some examples, the user 506 presses, at Step 802, and holds the press of the button 102 of the doorbell 100 for a predetermined period of time, at Step 804. This predetermined period of time may be the amount of time the doorbell 100 takes to change a color of the light 104 of the doorbell 100 a certain number of times and/or to a predetermined color. According to some examples, the predetermined period of time is the amount of time the light 104 of the doorbell 100 takes to rotate through a color sequence of colors, including the series flashing green, flashing dark blue, flashing yellow, and flashing cyan. In some examples, the user 506 holds the button press for about 60 seconds. According to some examples, the user 506 holds the press for the predetermined period of time and/or releases the press after the predetermined period of time, at Step 806. Then, software in the doorbell system 200 tells the doorbell 100 to restart and the doorbell 100 recognizes the instruction and transitions from the AP Mode to the vacancy mode, at Step 808. This may result in the doorbell 100 making this transition and no longer searching for and/or being connected to a wireless network 408. In this mode, the doorbell may only ring the chime 402 when the button 102 is pressed and may not have any other features available. Between Step 806 and Step 808, the light 104 may flash cyan.

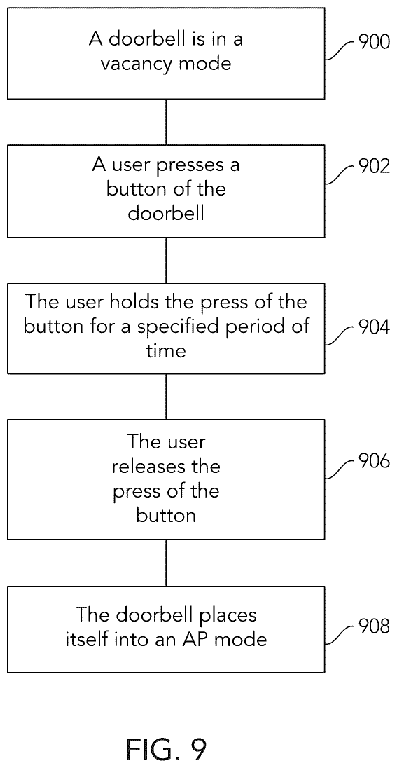

FIG. 9 illustrates a process flowchart, according to some embodiments. This figure shows a series of steps that may be used when the doorbell 100 is in the vacancy mode, at Step 900. In some examples, the user 506 wants to put the doorbell 100 into the AP Mode. In some examples, this change of modes is done manually. According to some examples, the user 506 presses, at Step 902, and holds the press of the button 102 of the doorbell 100 for a predetermined period of time, at Step 904. This predetermined period of time may be the amount of time the doorbell 100 takes to change a color of the light 104 of the doorbell 100 a certain number of times and/or to a predetermined color, such as flashing green. In some examples, the user 506 holds the button press for less, the same, or more time than in the flowchart of FIG. 8. According to some examples, after the user 506 holds the press for the predetermined period of time and/or releases the press after the predetermined period of time, as Step 906, software in the doorbell system 200 tells the doorbell 100 to restart and the doorbell 100 recognizes the instruction and transitions from the vacancy mode to the AP Mode, at Step 908. Upon entering AP Mode, the light 104 may flash red and/or green. The transition may result in the doorbell 100 making this transition and beginning to search for and/or connect to a wireless network 408, allowing the user 506 to connect the doorbell 100 to the wireless network 408 and access features limited to the AP Mode.

FIGS. 1-3 illustrate front views of the doorbell 100, according to some embodiments. The doorbell 100 can include a camera 300, which can be a fisheye camera and/or a camera located inside of a dome or spherical holder. The camera 300 can be configured to allow the user or installer to adjust the orientation of the camera 300 by moving an orientation feature. Adjusting the orientation of the camera 300 can include inserting a manipulation tool, such as a pin, paperclip, or needle, into the orientation feature, which can be a hole, a cylindrical hole, a lumen, and/or a shaft. Once the manipulation tool is coupled to the orientation feature, the user or installer can move the camera 300 like an eye can move in an eye socket.

The camera 300 can include a fisheye lens, which can produce a visual distortion to create a wide panoramic or hemispherical image. The fisheye lens can create a broader field of view than would be possible without a fisheye lens. The camera 300 may be a domed shape, although some embodiments include a non-domed camera 300. The doorbell 100 can include the camera 300, a microphone, a speaker, and/or a button 102 coupled together in a single unit (e.g., at least partially inside an outer housing).

The camera 300 can include a domed enclosure and an orientation feature, which can be a hole. The camera 300 can also include a lens, which can be transparent and/or translucent glass or plastic. The camera 300 can be electrically coupled to other parts of the doorbell 100 by a flex circuit, wires, cables and/or flexible conductors. The camera 300 may be secured between a cover and a printed circuit board (“PCB”). A front portion of the camera 300 may fit in a hole in the cover and a back portion of the camera 300 may fit in a hole in the PCB. In some examples, a computing device 202 can adjust the camera's viewing angle and/or zoom settings.

In some examples, the cover is translucent to allow infrared (“IR”) light from IR light emitting diodes (“LEDs”) to exit the doorbell 100 to illuminate visitors to enable nighttime video. The cover may appear opaque or semi-opaque, but allows IR light to pass. In some examples, the cover has a visible light transmission of at least 10% and/or less than 90%; at least 25% and/or less than 80%, or at least 35% and/or less than 75%. In some examples, the cover has an IR light transmission of at least 30% and a visible light transmission of less than 90%; an IR light transmission of at least 40% and a visible light transmission of less than 80%; or an IR light transmission of at least 50% and a visible light transmission of less than 50%. In some examples, the cover allows IR light to exit the doorbell 100 but does not allow people to view into the doorbell in normal lighting conditions (i.e., 50 foot-candles).

Light sources, such as IR LEDs, can be located in an interior portion of the doorbell 100. The light sources can be oriented to within 30 degrees of the viewing orientation of the camera 300 such that the light sources are configured to illuminate the camera's 300 field of view and/or objects located in front of the camera 300. The translucent or semi-translucent cover can be located between the light sources and objects in front of the camera 300. The cover can be configured to obscure visibility into the interior portion of the doorbell 100. The cover can be configured to enable light from the light sources to illuminate the camera's 300 field of view and/or objects located in front of the camera 300.

In some examples, the doorbell 100 includes an outer housing and the outer housing includes a translucent or semi-translucent cover configured to allow light from light sources to travel from an interior portion of the doorbell 100 to an area in front of the doorbell 100 (e.g., to an area outside of the doorbell 100). Light sources can be located beneath the cover and can be oriented to emit light through the cover. In some examples, the cover couples a camera 300 with the outer housing.

In some examples, a tube leads from the orientation feature (e.g., a hole in the outer surface of the camera 300 dome) to a microphone located inside of the doorbell 100 (e.g., on a printed circuit board). The microphone can be located outside of the camera 300 on a printed circuit board. The microphone can be located inside of the camera 300 (e.g., inside of the spherical assembly that houses at least a portion of the camera 300). The tube can be configured to conduct sound and/or direct sound to a microphone located inside of the doorbell 100. The tube, microphone, and orientation feature are not included and/or indicated in some figures in the interest of clarity.

The doorbell 100 can include a battery, which can be rechargeable. Some examples include alkaline or lithium batteries. In some examples, the battery can be a 3,500 mAh battery and/or a battery between 1,000 mAh and 5,000 mAh.

The lens can allow light, such as IR light, to enter the doorbell 100 to enable an IR detector to sense and/or detect the IR light. Several embodiments include the IR detector. The IR detector can be used to determine if a visitor is near the doorbell 100 due to the unique IR signature and/or characteristics of people compared to non-living objects. The IR detector can be a thermal or photonic IR detector. The doorbell system 200 can be configured to distinguish between the IR characteristics of people and background IR characteristics. Thus, the system can determine if a visitor is in an entryway (e.g., in front of a door). The IR detector can be a motion sensor.

In several embodiments, the IR detector is a light detector, which can be used to distinguish day (i.e., light hours) from night (i.e., dark hours). In some embodiments, day versus night is distinguished based on time rather than light. The communication system 500 can have a Day Mode and a Night Mode, wherein Night Mode reduces, alters, or precludes alerts to the user.

Pressing the button 102 of the doorbell 100 can activate a switch, which can cause a chime 402 to emit a sound and/or initiate a communication request to the user 506. In some examples, pressing the button 102 can trigger the doorbell 100 to record a fingerprint of the visitor. The lens can be large enough to enable the doorbell 100 to take a picture (e.g., an IR image) of the visitor's finger. In some examples, the fingerprint is compared against a database of fingerprints to identify the visitor and/or to classify the visitor. Visitors in a welcome class (e.g., family, a person with permission to enter) can cause a door 20 to open (e.g., the doorbell 100 can unlock the door 20). In some examples, the button 102 is a fingerprint reader that can optically scan fingerprints when visitors touch a glass imaging window.

The doorbell 100 can include a chip (e.g., integrated circuits, microprocessor, computer) and a memory. The doorbell 100 can also include a microphone and/or a speaker. The speaker can include a flat speaker and a sound chamber configured to amplify an emitted sound. The flat speaker can be located in the sound chamber. Some doorbell 100 embodiments include a proximity sensor. In some examples, the doorbell 100 includes a wireless communication module, such as a Wi-Fi module. The communication module can have an integrated antenna. In some examples, an antenna is contained within the outer housing.

In some examples, a mounting bracket is molded from plastic or machined from metal, such as aluminum. The mounting bracket can include screw holes, which can be slots configured to allow a threaded portion of a screw to pass, but not allow the head of the screw to pass. A wire hole can be located in the center of the mounting bracket. Electrical wires 404 from the building 10 can pass through the wire hole and couple to electrical connectors.

The outer housing can include grooves that extend radially outward from a central axis of the outer housing. The grooves can be located on an inner diameter and/or inner surface of the outer housing, which can be part of the doorbell 100. Some examples include one continuous groove along an inner surface while other embodiments include separate grooves. Separate grooves can help control the angular orientation of the doorbell when it is mounted to a wall. Screws can be used to couple the mounting bracket to a wall of the building 10, a structure, and/or an enclosure.

The mounting bracket can have protrusions that can extend radially outward from the mounting bracket. The protrusions can be configured to fit inside the grooves. Flex zones (e.g., holes, open areas, slots, flexible material) can be located radially inward from the protrusions. The flex zones can allow the protrusions to move radially inward as the outer housing is pushed onto the bracket (e.g., when the bracket is mounted to a wall).

Moving radially inward can help the protrusions clear lips associated with the grooves. The lips can be located closer to the back side of the outer housing or doorbell 100 than the grooves such that, in some embodiments, the lip moves past the protrusion before the protrusion reaches the groove. The lips can extend further radially inward than the grooves. In some embodiments, the outer housing is configured to flex radially outward (e.g., at least in areas within 1 centimeter of the lips and/or grooves) to enable the lips to clear (e.g., snap over, move beyond) the protrusions.

The protrusions can have a first side, which can be a front side (i.e., configured to be mounted facing away from a wall of the building 10). The protrusions can have a second side, which can be a back side (i.e., configured to be mounted facing towards a wall of the building 10). In some examples, the first side of the protrusion includes a rounded or chamfered edge to facilitate pushing the outer housing onto the bracket to create a snap fit.

In some examples, the outer housing includes protrusions that extend radially inward and the bracket includes grooves and/or indentations that extend radially inward to capture the protrusions of the outer housing. In some examples, the outer housing snaps onto the bracket. The outer housing may be coupled to the bracket by threads (e.g., screws with threads, threads along the outer perimeter of the bracket).

The outer housing can lock onto the bracket to reduce the likelihood of theft. The outer housing and bracket can be configured such that mounting means (e.g., protrusions, screws) are hidden when the outer housing is coupled to the bracket. In some examples, the outer housing covers coupling members (e.g., protrusions, screws) when the outer housing is coupled to the bracket.

Several examples can establish a visitor's identity by detecting a signal from a device associated with the visitor. Examples of such a signal include Bluetooth, Wi-Fi, RFID, NFC, and/or cellular telephone transmissions.

Some method embodiments include detecting a visitor with a doorbell 100. The methods can include causing the user interface 204 to display on a remote computing device 202 due to the detection of the visitor (e.g., with or without user 506 interaction). The methods can include displaying video from the doorbell 100 and/or audio from the doorbell 100 before the user 506 accepts two-way communication 508 with the visitor. The methods can include displaying video from the doorbell 100 and/or audio from the doorbell 100 before the user 506 accepts the visitor's communication request. The methods can include the computing device 202 simultaneously asking the user 506 if the user 506 wants to accept (e.g., answer) the communication request and displaying audio and/or video of the visitor. For example, in some embodiments, the user 506 can see and hear the visitor via the doorbell 100 before opening a means of two-way communication 508 with the visitor.

Some embodiments include a media roll or other means to record a certain amount of data and then record over some of the data, such as the oldest data or low-priority data. Some examples of the doorbell system 200 record over data that is older than seven days, 14 days, or one month. Some doorbells 100 can be configured to continuously record video and/or audio to a media roll, which can be viewed on a remotely located computing device 202.

In several examples, the doorbell system 200 (e.g., software, computing device 202, doorbell 100 in FIG. 1) can be configured to allow a user 506 to customize where, when, and/or how notifications (e.g., doorbell communication requests) are received on one or more computing devices (e.g., 202 in FIG. 2). In some examples, the doorbell system 200 is configured to only notify a user's 506 smartphone at certain times of day or night. In some examples, the doorbell system 200 is configured to only notify a user's 506 smartphone when the smartphone is in a predetermined proximity to the building 10 (e.g., within 10 feet, within 50 feet, within 100 feet). The doorbell system 200 can be configured to only notify a user's 506 smartphone when the smartphone is at or near a specified location. In some examples, the doorbell system 200 is configured to only notify a user's 506 smartphone when the smartphone is connected to a home network. The doorbell system 200 can be configured to only notify a first user's smartphone when a second user's smartphone is present or absent. In some examples, the doorbell system 200 is configured to send only text messages at certain times of day (rather than sending other types of notifications, such as launching an app and then displaying an image). In some examples, the doorbell system 200 is configured to send one-way audio or one-way video (rather than two-way audio and/or two-way video) if the user 506 is away from home. The doorbell system 200 can be configured to block notifications during certain times, when the user 506 is in certain places (e.g., in a meeting, in the building 10 to which the doorbell 100 is attached), and/or if the user 506 prefers not to receive notifications.

In some examples, a doorbell 100 and/or a computing device 202 communicates with a baby monitor. If the baby monitor detects indicators that a baby is sleeping (e.g., the presence of a baby that is not moving, as sensed by an IR motion detector) the communication system 500 can disable the doorbell sound to avoid disturbing the baby's sleep. Some embodiments work the same way except that the baby is replaced by an adult person.

Some examples include administrative privileges. These privileges can include administrative abilities and the ability to alter settings. The administrative privileges can be password protected. The administrator can add and remove notification recipients and/or computing devices 202. For example, a user 506 who sets up the communication system 500 by initially pairing a computing device 202 with a doorbell 100 can be given administrative privileges and the highest priority (as explained herein). This administrative user can give permissions and priorities to other users and computing devices 202. This administrative user can choose settings. This administrative user can give or transfer administrative rights to another user and/or computing device 202.

Several examples include a mode to address overly frequent notifications. This mode may be called Peaceful Mode. For example, on Halloween, the doorbell 100 may sense doorbell button 102 presses, motion, proximity, and/or sound more frequently than the user 506 wants to be notified. Some examples include a maximum notification setting (e.g., the maximum number of notifications that will be communicated to the user per unit of time). If the maximum number of notifications is exceeded, then the doorbell 100 can enter Peaceful Mode. In several embodiments, the maximum number of notifications is three notifications per hour; four notifications per hour; five notifications per hour; seven notifications per hour; ten notifications per hour; four notifications per day; seven notifications per day; seven notifications per 24 hours; or fifteen notifications per 24 hours. In some examples, the user 506 can set the maximum number of notifications and/or the time period over which the notifications are counted towards a maximum number. In some examples, the user 506 can set the maximum number of notifications via the software, a website configured to communicate with the server 504, and/or a user interface 204.

In some examples of Peaceful Mode, the doorbell system 200 stops alerting the user 506 via the computing device 202. For example, a visitor pressing the doorbell button 102 could cause a sound (e.g., a chime) to be emitted inside or near the building 10 but would not cause the computing device 202 to notify the user 506.

In some examples of Peaceful Mode, the doorbell system 200 stops alerting the user 506 via the chime 402 located inside of the building 10. For example, a visitor pressing the doorbell button 102 could cause the computing device 202 to notify the user 506, but would not cause a sound (e.g., a chime) to be emitted inside or near the building 10.

In some examples of Peaceful Mode, the doorbell system 200 stops alerting the user 506 via the chime 402 located inside of the building 10 and via the computing device 202. For example, a visitor pressing the doorbell button 102 would not cause a sound (e.g., a chime) to be emitted inside or near the building 10 and would not cause the computing device 202 to notify the user 506.

In some examples of Peaceful Mode, the doorbell system 200 does not automatically stop alerting the user 506 via the computing device 202 and does not automatically stop alerting the user 506 via the chime 402, but instead, once the maximum number of notifications is exceeded, the software, computing device 202, and/or user interface 204 asks the user 506 if the user 506 wants to enter Peaceful Mode, turn off notifications via the computing device 202, and/or turn off notifications via the sounds emitted inside and/or near the building 10 (e.g., chimes). In several examples, the software, computing device 202, and/or user interface 204 asks the user 506 how long the user 506 wants to turn off notifications via the computing device 202, and/or turn off notifications via the sounds emitted inside and/or near the building 10. In some examples, notifications are turned off for at least 15 minutes and/or less than 4 hours; at least 5 minutes and/or less than one hour; or at least 30 minutes and/or less than 24 hours.

In some examples of Peaceful Mode, Peaceful Mode does not turn off notifications but instead reduces the volume, frequency, and/or intensity of notifications. In some examples of Peaceful Mode, the chime 402 volume can be reduced by at least 30 percent, at least 50 percent, or at least 70 percent. Another variant of Peaceful Mode, Sleep Mode, may turn off all notifications and sounds, while still pushing an alert to a user's remote computing device. In some examples of Peaceful Mode, the alerts to the computing device 202 switch to Non-auditory Mode such that the computing device 202 does not ring or send auditory alerts, but instead sends alerts such as vibrations (with little or no sound) and/or visual alerts (e.g., messages on the user interface 204).

Since at least the early 1900s, doorbells have been hardwired into building power circuits. Even before that, they were able to run on their own circuits and/or batteries. At the time, doorbells for a home could often be seen as status symbols for those wealthy enough to afford them. With the implementation of plastics and the expansion of individual homes, doorbells became cheaper and much more common for the average household. However, one major problem persisted: the inability of a homeowner to know their doorbell is being rung unless they are home. While the advancement of doorbells brought the ability for a homeowner to know from anywhere they or their devices are that their doorbell has been rung, one of the major issues that has yet to be addressed is the inability to change between different modes and/or features in a doorbell. Further, once a homeowner has made their choice, they would be required to buy another doorbell or device if they decided they wanted the other option instead.

One of the common requirements of doorbells is the need to connect them to a wireless network. This can be difficult for those who are not technologically savvy or who have a bad wireless connection. When doorbells are not connected to a wireless network, they often display or otherwise make known that they have been disconnected or are struggling to find any connection. One of the more common ways they do this is by blinking a light on the doorbell itself. While the homeowner inside the home must solve the problem they may find more pressing (their doorbell no longer works), the doorbell has now become a nuisance to all those outside the home. This problem may be compounded when doorbells are installed when constructing apartment buildings and housing developments, due to the number of doorbells that would be required and the lack of wireless networks to connect them to until someone moves in, which could mean months of constant blinking of the doorbells or even having problems passing inspections. For ease of reference, the word “home” will be used to refer to any type of house, apartment, dwelling, etc., that the doorbell may be installed in and/or on.

In some areas, there are requirements for doorbells to be installed in new construction in every home. Additionally, the doorbells often need to actually ring during inspections, even if no one lives there. When a builder wants to install doorbells with certain features on every home, perhaps for the ability to advertise the new homes as luxury homes, these requirements can be difficult to complete for a number of reasons. One issue is that for some doorbells to ring, they must be connected to a wireless network and some sort of chime, phone, or other device not physically connected to the doorbell. During or prior to inspection, the builder would need to connect each individual doorbell to at least one wireless network and device and confirm the doorbell works as intended. However, the lack of individual wireless networks in the homes during construction means the builder may have to connect a series of different wireless networks or a single wireless network with a series of range extenders, access points, or other devices that allow a doorbell a great distance from the wireless network to connect to it. In addition, due to the requirements of a doorbell in every home, the builder will be left with a number of doorbells, potentially over 100, that will either require continued connection to the wireless network(s) or that will give error messages and/or blinking lights until someone moves into the home. This problem is made even worse if the doorbells run on battery power, as the batteries would be likely to be drained prior to anyone moving in.

The present doorbell system allows a user, which may be the builder and/or homeowner, to remove many of these issues. The doorbell may allow for the user to wire it into the doorbell circuit of a home, which may provide power to the doorbell and/or connect it to a chime. This can solve the problem of a battery being drained before anyone moves into the home and may allow the doorbell to ring a chime inside the home. When powered, the doorbell may begin in a vacancy mode or an AP Mode.

In the vacancy mode, most, if not all, of the features of a doorbell may be unavailable but the chime may ring when a button on the doorbell is pressed. Vacancy mode could also require less power and/or allow the doorbell to pass inspection while the home is being constructed. This mode may work quite similarly to a mechanical doorbell, where a user can press a doorbell button, which in turn completes the doorbell circuit, sending power to a chime that rings, buzzes, and/or otherwise makes noise.

In the AP Mode, the doorbell may begin by searching for a wireless network connection. At this point, a user may pair a remote computing device, such as a phone, to the doorbell and connect the doorbell to a wireless network, such as a home Wi-Fi network. Once connected, the user may adjust settings of the doorbell system through the use of a program, phone application, or the like. The settings may allow for the doorbell to have different functions, may connect the doorbell to other computing devices, may adjust a camera in and/or on the doorbell, and/or may perform functions common for a doorbell.

One of the unique features of the doorbell system is that it gives the user the choice of how they want their doorbell to work and when. For example, the doorbell may be in the vacancy mode but the user wants to have a doorbell that only digitally rings when they are not at home. The user can transition the doorbell from the vacancy mode to the AP Mode through a number of means, such as pressing and/or holding a button, flipping a switch, and/or the like. Once in AP Mode, the user may pair the doorbell with any number of devices and set parameters for what they want the doorbell system to do. In this example, the user may pair the doorbell with their phone and connect it to a security system that the doorbell system may use to determine whether there is anyone in the home when the button of the doorbell is pressed. Regardless of the parameters, the doorbell may also still maintain the ability to ring a chime.

In another example, the user may want the opposite, where the doorbell is in AP Mode, but they would like the doorbell to only ring a chime and not connect to any wireless network or other digital devices. Similar to the previous example, the user may transition the doorbell from one mode to the other through a number of means, such as pressing and/or holding a button, flipping a switch, and/or the like.

The doorbell may be able to function in and/or transition between any number of modes. The changing of modes may be done at the will of the user and/or may be changed from one mode to another and back again any number of times. The doorbell may even change from one mode to another on its own. For example, if the doorbell is in the AP Mode but is not connected to a wireless network, it may restart itself and/or transition to the vacancy mode on its own. This could be especially useful when many doorbells are installed during the construction of the homes, as the doorbells may not require any constant connection to a wireless network and may be able to change to the vacancy mode on their own. If the doorbell flashes a light and/or otherwise signals that it is not connected to a wireless network, the self-transition to vacancy mode could eliminate the problem of the constant non-connected signals, which may quickly become a public nuisance.

The present doorbell system may allow for any number of doorbell abilities and/or features, such as video and/or audio to and/or from the user, motion detection, connection to multiple devices, etc. Similar to the changeability of the modes, the doorbell system may also allow for changeability in the doorbell abilities and/or features, such as allowing a user to set parameters as to when, how, and/or even where they want a certain ability and/or feature. For example, the user may have two doorbells controlled by the same phone application, one at their front door and one at their back door. The user may set parameters such that the front door records normal video during the day, night vision video at night, and has motion detection only on Tuesdays and such that the back door records heat vision video every night between the hours of 2 am and 5 am and a camera recording the video follows and zooms in on any motion it detects. It may even automatically play audio of dogs barking and shine a light toward the motion. In addition to these abilities and/or features, the doorbell system may allow for changes to the abilities and/or features at any time. The doorbell may also gain additional and/or alternate functionality through the use of software updates and the like, which may be implemented by a processor.

An additional description of the above disclosure is provided herein. For any method and doorbell described herein, placing the doorbell in AP mode and/or placing the doorbell in vacancy mode may occur automatically or manually.

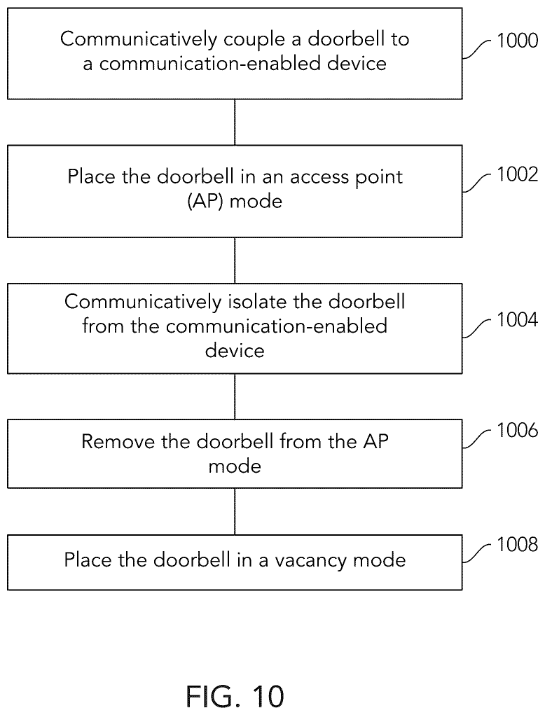

FIG. 10 illustrates a flowchart depicting a method of placing a doorbell in an AP mode and in a vacancy mode, according to some embodiments. In some embodiments, the method includes communicatively coupling a doorbell to a communication-enabled device (at step 1000). The communication-enabled device may be any means of routing communication from the doorbell to another device. This may be accomplished through devices such as routers, modems, mesh systems, etc. For example, the communication-enabled device may provide internet connectivity, network connectivity over a cellular network, or other network connectivity to the doorbell. In some embodiments, the doorbell includes a communications chip. In any embodiment, communication between the doorbell and the communication-enabled device may occur via wireless fidelity (Wi-Fi), Bluetooth, cellular data, or any combination thereof. In embodiments including a communication chip, the communication chip may be able to communicatively couple the doorbell to a hub independent of the remote computing device, such as Starlink®.

According to some embodiments, the method includes placing the doorbell in an AP mode (at step 1002). This may include coupling the doorbell to a chime that is spaced apart from the doorbell. In some embodiments, this permits the doorbell to enable an alert to be received by a remote computing device, a noise to be emitted by the chime, or both. According to some embodiments, this coupling of the doorbell to the chime may include electrically coupling the chime, communicatively coupling the doorbell to the chime, or both. The chime may be referred to as a mechanical chime, as opposed to a digital chime, where the chime is configured to emit a noise via the electrical wiring coupled between the doorbell and the chime.

The method may include communicatively isolating the doorbell from the communication-enabled device (at step 1004). In embodiments including a communications chip, isolating the doorbell from the communication-enabled device may include disabling the communications chip. In some embodiments, the communications chip is placed into a hibernation mode, where the communications chip is provided a small amount of power—enough to keep the communications chip on, but not enough to permit the communications chip to output a communications signal (for example, to a communication-enabled device).

In some embodiments, the method includes removing the doorbell from the AP mode (at step 1006). According to some embodiments, the method includes placing the doorbell in a vacancy mode (at step 1008). In such a vacancy mode, the doorbell may remain coupled to the chime to enable the noise to still be emitted from the chime. This may be useful in situations where the doorbell needs to continue to function despite not being connected to the device of a user or resident of the unit to which the doorbell is attached, such as during building inspections. The doorbell may be placed in the vacancy mode through actuating the doorbell, either through a specific sequence of button presses, or a single, prolonged button press.

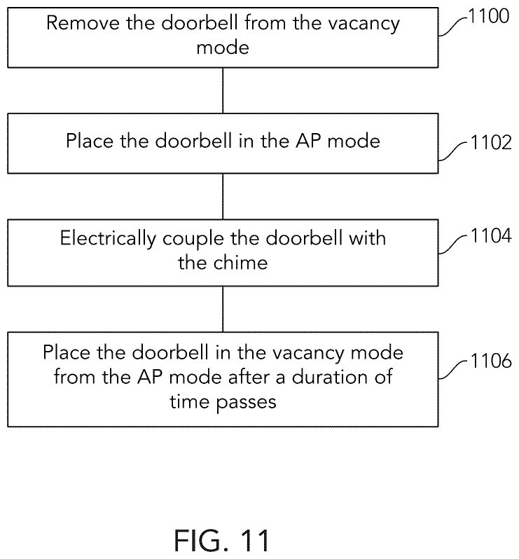

FIG. 11 illustrates a flowchart depicting another method of placing the doorbell in the AP mode from the vacancy mode, according to some embodiments. The method may include removing the doorbell from the vacancy mode (at step 1100). In some embodiments, the method includes placing the doorbell in the AP mode (at step 1102). Placing the doorbell in AP mode may occur simultaneous with removing the doorbell from vacancy mode. The doorbell may be placed in the AP mode through actuating the doorbell, either through a specific sequence of button presses, or a single, prolonged button press. In embodiments where the doorbell is capable of being placed in the vacancy mode through a specific sequence of button presses or a single, prolonged button press, the sequence or length of button press to place the doorbell in AP mode may be different from that used to place the doorbell in vacancy mode.

According to some embodiments, the method includes electrically coupling the doorbell with the chime (at step 1104). In some embodiments, the doorbell may include two communications chips—one for communicating with the communication-enabled device, and a second communications chip for communicatively coupling the doorbell to the chime (e.g., a digital chime). This second communications chip may permit the chime to be activated by the doorbell without a wired connection. According to some embodiments, this second communications chip is able to communicate with the chime via Wi-Fi, Bluetooth, cellular data, or combinations thereof.

The method may include placing the doorbell in the vacancy mode from the AP mode after a duration of time passes (at step 1106). If the doorbell is unable to communicate with the communication-enabled device for a prolonged period, it may be indicative that an event has occurred, such as the resident moving out, or a natural disaster occurring. In order to prevent the doorbell from constantly checking for a connection to a communication-enabled device and entering in a loop of reboots, after a specified period of time has passed the doorbell may automatically enter the vacancy mode, preventing it from checking for these communication-enabled devices. In some embodiments, this period is about 1 hour, 12 hours, 24 hours, one or more days, one week, two weeks, a month, two months, 6 months, or 1 year.

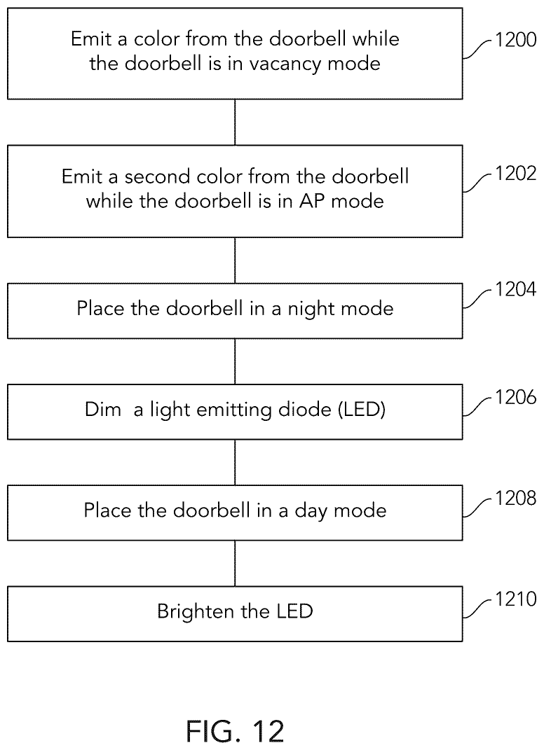

FIG. 12 illustrates a flow chart depicting a method of various light emissions from the doorbell, according to some embodiments. In some embodiments, the method includes emitting a color from the doorbell while the doorbell is in vacancy mode (at step 1200). According to some embodiments, the method includes emitting a second color from the doorbell while the doorbell is in AP mode (at step 1202). This may make it easier to see at a glance, which residence is occupied. Additional colors may be emitted from the doorbell based on the aforementioned and forthcoming modes (e.g., night mode, day mode, sleep mode, non-auditory mode, etc.). A user may find it preferable to keep all alternate modes the same color as the AP mode, so as to not inform outside visitors that their chime or remote computing device is disabled. However, the colors may be customizable, making it difficult for a non-resident to understand what each color means.

The method may include placing the doorbell in a night mode (at step 1204). In some embodiments, the method includes dimming an LED (at step 1206). When the ambient light level around the doorbell is dark, as is usually the case during the nighttime, a user may not desire a bright light shining at them. As such, in some embodiments, the LED dims in response to detecting a low ambient light level.

According to some embodiments, the method includes placing the doorbell in a day mode (at step 1208). The method may include brightening the LED (at step 1210). When the ambient light level around the doorbell is brighter, as is usually the case during the daytime, a user may desire a brighter LED in order to more easily see it. As such, in some embodiments, the LED brightens in response to detecting a high ambient light level.

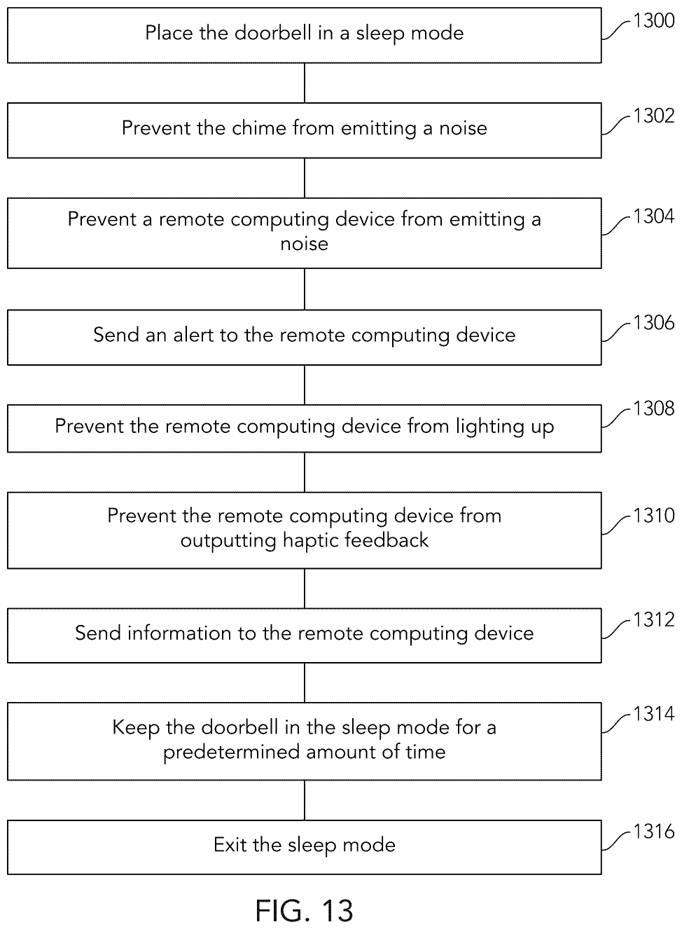

FIG. 13 illustrates a flow chart depicting a method of placing the doorbell in a sleep mode, according to some embodiments. In some embodiments, the method includes placing the doorbell in a sleep mode (at step 1300). The user may be capable of placing their doorbell in the sleep mode through an application running on their remote computing device. The user may additionally be capable of setting a start and stop time for the sleep mode, permitting the user to prevent the doorbell from interrupting their planned sleep schedule.

According to some embodiments, the method includes preventing the chime from emitting a noise (at step 1302). The method may include preventing a remote computing device from emitting a noise (at step 1304). A user may desire no audible interruptions while they are trying to sleep. As such, in some embodiments, the doorbell is unable to cause a noise to occur within the user's residence while it is in sleep mode.

In some embodiments, the method includes sending an alert to the remote computing device (at step 1306). The user may still want to know when someone has approached their doorbell and/or residence while they are sleeping. As such, in some embodiments, the doorbell still pushes an alert through to the remote computing device (e.g., without making an audible alert), which the user can review when they have woken up.

According to some embodiments, the method includes preventing the remote computing device from lighting up (at step 1308) as a result of the doorbell being activated by a visitor. The method may include preventing the remote computing device from outputting haptic feedback (at step 1310). Users of the doorbell may be light- or sound-sensitive. In some cases, the light from a phone screen, or the rumbling from a phone's haptics may be enough to wake a user. In some embodiments, the doorbell prevents the remote computing device from lighting up or outputting this haptic feedback while in sleep mode in order to prevent this possibility.

In some embodiments, the method includes sending information to the remote computing device (at step 1312). According to some embodiments, the method includes keeping the doorbell in the sleep mode for a predetermined amount of time (at step 1314). The method may include exiting the sleep mode (at step 1316). As stated above, the doorbell may be able to be programmed with start and stop times, thereby placing the doorbell back in AP mode when the user expects to have awakened.

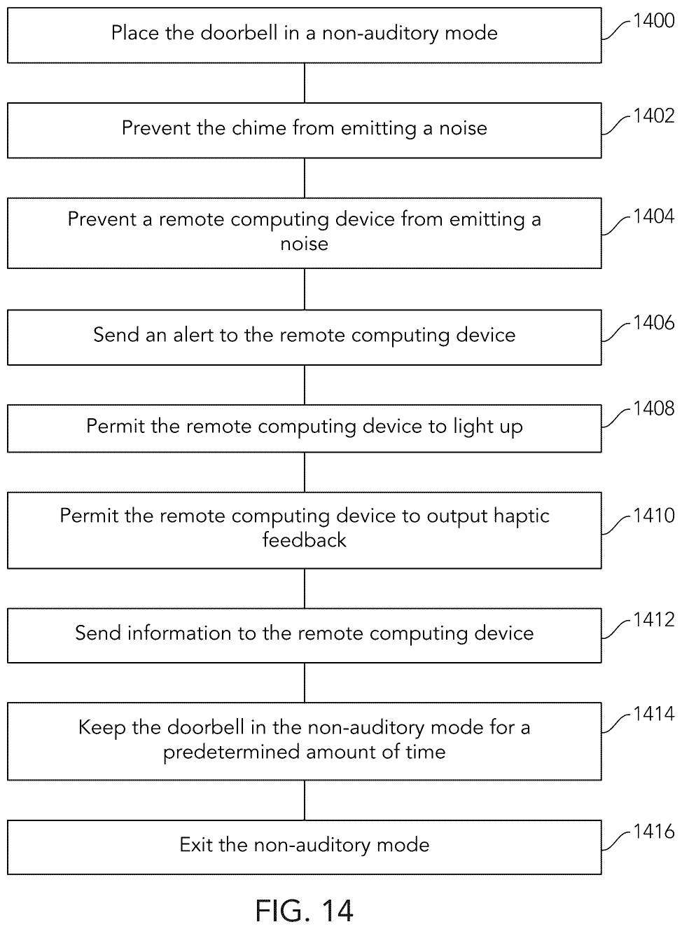

FIG. 14 illustrates a method of placing the doorbell in a non-auditory mode, according to some embodiments. In some embodiments, the method includes placing the doorbell in a non-auditory mode (at step 1400). According to some embodiments, the method includes preventing the chime from emitting a noise (at step 1402). The method may include preventing a remote computing device from emitting a noise (at step 1404). The user may desire no noise to come from the doorbell during certain activities, such as a movie night, or a meeting with a client. During these periods, the user may place the doorbell in the non-auditory mode.

In some embodiments, the method includes sending an alert to the remote computing device (at step 1406). According to some embodiments, the method includes permitting the remote computing device to light up (at step 1408). The method may include permitting the remote computing device to output haptic feedback (at step 1410). While the user may not want a noise to come through on either the chime or their remote computing device, the user may still want to be notified when someone has approached their residence or attempted to ring their doorbell. In this case, their remote computing device, such as a phone, may still light up and provide haptic feedback to notify the user that someone is at the door.

In some embodiments, the method includes sending information to the remote computing device (at step 1412). According to some embodiments, the method includes keeping the doorbell in the non-auditory mode for a predetermined amount of time (at step 1414). The method may include exiting the non-auditory mode (at step 1416). Using the example of a meeting from above, if a user plans on having a one-hour meeting, they may set the doorbell to be in non-auditory mode for only one hour. Upon the end of the one-hour period, the doorbell may then automatically return to AP mode.

Any of the preceding disclosure may also be accomplished through the use of a non-transitory, computer-readable media, executable by a processor. In some embodiments, this may take the form of a chip that is installable in a doorbell, either a dumb doorbell or a smart doorbell with limited or different capabilities, permitting the doorbell to perform the actions described above.

The present disclosure includes a method for activating a doorbell system, which may include connecting a doorbell to a power source. In some examples, the method includes allowing the doorbell to search for a Wi-Fi network connection. According to some examples, the method includes avoiding the doorbell finding the Wi-Fi network connection. The method may include permitting the doorbell to restart. In some examples, the method includes leaving the doorbell to restart a number of times.

According to some examples, the power source is a wired power source. The power source may be a battery power source. In some examples, avoiding the doorbell finding the Wi-Fi network connection includes removing the presence of the Wi-Fi network connection from an area near the doorbell. In some examples, permitting the doorbell to restart includes waiting for the doorbell to restart after a specified amount of time. The specified amount of time may be one hour. In some examples, the number of times is 345 times.

In some examples, the method includes allowing the doorbell to place itself into a vacancy mode. According to some examples, the vacancy mode allows for a press of the doorbell. The press of the doorbell may activate a chime. In some examples, the doorbell includes a status indicator light. According to some examples, the status indicator light flashes. The status indicator light may change colors.

The disclosure also includes another method for activating a doorbell system, which may include connecting a doorbell to a power source. Activating the doorbell may include a person interacting with the doorbell, such as by pushing a button of the doorbell. In some examples, the method includes joining the doorbell to a Wi-Fi network connection. According to some examples, the method includes allowing the doorbell to enter an AP Mode. The method may include pressing the doorbell. In some examples, the method includes holding the doorbell press for a period of time. According to some examples, the method includes releasing the doorbell press. The period of time may include a pattern time length.

In some examples, the method includes allowing the doorbell to place itself into a vacancy mode. According to some examples, the AP Mode allows for a press of the doorbell. The press of the doorbell may activate a chime. According to some examples, the press of the doorbell activates a video.

The disclosure additionally includes a method for changing a doorbell mode, which may include pressing a doorbell. In some examples, the method includes holding the doorbell press for a period of time. According to some examples, the method includes releasing the doorbell press. The period of time may include a pattern time length. In some examples, the period of time is sixty seconds. According to some examples, the method includes allowing the doorbell to place itself into a connected mode.

The disclosure further includes another method for changing a doorbell mode, which may include receiving a mechanical input. In some examples, the mechanical input is at a doorbell. According to some examples, the method includes triggering a software communication. The software communication may be to an internal hardware of the doorbell. In some examples, the method includes syncing the doorbell to a remote computing device.

Some of the components listed herein use the same number from figure to figure. It should be appreciated these components use the same numbers solely for ease of reference and to facilitate comprehension for the reader. While these components may use the same numbers, differences may be present in these components as illustrated in the various figures in which they appear and as described in the specification herein.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The foregoing may be accomplished through software code running in one or more processors on a communication device in conjunction with a processor in a server running complementary software code.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

It is appreciated that in order to practice the method of the foregoing as described above, it is not necessary that the processors and/or the memories of the processing machine be physically located in the same geographical place. That is, each of the processors and the memory (or memories) used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the foregoing, be performed by a single component. Further, the processing performed by one distinct component as described above may be performed by two distinct components. In a similar manner, the memory storage performed by two distinct memory portions, as described above, may, in accordance with a further embodiment of the foregoing, be performed by a single memory portion. Further, the memory storage, performed by one distinct memory portion, as described above, may be performed by two memory portions.

Further, various technologies may be used to provide communication between the various processors and/or memories, as well as to allow the processors and/or the memories of the foregoing to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the foregoing. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software may instruct the processing machine what to do with the data being processed.

Further, it is appreciated that the instructions or set of instructions used in the implementation and operation of the foregoing may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the foregoing. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the foregoing. Rather, any number of different programming languages may be utilized as is necessary and/or desirable.

Also, the instructions and/or data used in the practice of the foregoing may utilize any compression or encryption technique or algorithm, as may be desired. An encryption module might be used to encrypt data. Further, files or other data may be decrypted using a suitable decryption module, for example.

As described above, the foregoing may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the foregoing may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the foregoing.

Further, the memory or memories used in the processing machine that implements the foregoing may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the foregoing, a variety of “user interfaces” may be utilized to allow a user to interface with the processing machine or machines that are used to implement the foregoing. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the foregoing, it is not necessary that a human user actually interact with a user interface used by the processing machine of the foregoing. Rather, it is also contemplated that the user interface of the foregoing might interact, i.e., convey and receive information, with another processing machine, rather than a human user. Accordingly, the other processing machine might be characterized as a user. Further, it is contemplated that a user interface utilized in the system and method of the foregoing may interact partially with another processing machine or processing machines, while also interacting partially with a human user.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

1-126. (canceled)

127. A system comprising:
a chime; and
a doorbell electrically coupled to the chime and configured to communicatively couple to a remote computing device, the doorbell spaced apart from the chime, the doorbell comprising a vacancy mode and an access point (AP) mode,
wherein when the doorbell is in the vacancy mode, the doorbell is communicatively isolated from the remote computing device such that the doorbell is configured to send an alert by emitting a noise via the chime, and
wherein when the doorbell is in the AP mode, the doorbell is communicatively coupled to the remote computing device such that the doorbell is configured to send an alert to the remote computing device.

128. The system of claim 127, wherein the doorbell is configured to emit a light comprising a color,
wherein the color is configurable by a user of the doorbell, and wherein the color is different when the doorbell is in the AP mode or the vacancy mode.

129. The system of claim 128, wherein the doorbell further comprises a communications chip configured to communicate with the remote computing device and a hub independently.

130. The system of claim 129, wherein the communications chip is configured to communicate via i) wireless fidelity (Wi-Fi), ii) Bluetooth, iii) cellular data, or iv) combinations thereof.

131. The system of claim 129, wherein the communications chip is disabled when in the vacancy mode and enabled when in the AP mode, and wherein entering the vacancy mode from the AP mode communicatively isolates the doorbell from the remote computing device.

132. The system of claim 127, wherein the doorbell comprises an actuator, and wherein the doorbell is configured to i) enter the AP mode from the vacancy mode through actuating the actuator, ii) enter the vacancy mode from the AP mode through actuating the actuator, or iii) both.

133. The system of claim 132, wherein the doorbell is configured to i) enter the AP mode from the vacancy mode through actuating the actuator for a first predetermined amount of time, ii) enter the vacancy mode from the AP mode through actuating the actuator for a second predetermined amount of time, or iii) both, and
wherein the first predetermined amount of time and the second predetermined amount of time are different.

134. The system of claim 127, wherein the doorbell is configured to enter the vacancy mode from the AP mode after a duration of time passes wherein the doorbell is not communicatively coupled to the remote computing device.

135. The system of claim 127, wherein the doorbell is a first doorbell, the system comprising a second doorbell, and wherein i) the first doorbell, ii) the second doorbell, or iii) both are configured to enter the vacancy mode from the AP mode by an input from a master user.

136. The system of claim 129, wherein the communications chip is a first communications chip, and the doorbell further comprises a second communications chip, and wherein the second communications chip is configured to communicate with i) the chime, ii) the hub, or iii) both.

137. The system of claim 136, wherein the first communications chip is configured to enter a hibernation mode when the doorbell is in the vacancy mode, wherein the second communications chip is configured to remain communicatively coupled to i) the chime, ii) the hub, or iii) both.

138. The system of claim 137, wherein the first communications chip enters the hibernation mode, the doorbell unpairs with all remote computing devices, and
wherein when the first communications chip exits the hibernation mode, the doorbell pairs with i) the remote computing device, ii) a different remote computing device, or iii) combinations thereof.

139. The system of claim 127, wherein the doorbell further comprises a light emitting diode (LED), and wherein the light emitting diode (LED) is configured to dim or brighten with respect to an ambient light level.

140. The system of claim 139, wherein the doorbell further comprises a sleep mode, and wherein when the doorbell is in the sleep mode, the doorbell is communicatively coupled to the remote computing device, and the doorbell is configured to prevent the noise being emitted from the chime, a noise being emitted by the remote computing device or both.

141. The system of claim 140, wherein when the doorbell is in the sleep mode, the doorbell is configured to send the alert to the remote computing device without the remote computing device i) lighting up, ii) outputting haptic feedback, or iii) combinations thereof.

142. The system of claim 140, wherein the doorbell is configured to i) enter or ii) exit, the sleep mode at i) a predetermined time of day, ii) a predetermined duration, or iii) by an input from a user.

143. The system of claim 127, wherein the doorbell further comprises a non-auditory mode, and wherein when the doorbell is in the non-auditory mode, the doorbell is communicatively coupled to the remote computing device, and the doorbell is configured to prevent the noise being emitted from the chime and a noise being emitted from the remote computing device.

144. The system of claim 143, wherein when the doorbell is in the non-auditory mode, the doorbell is configured to send the alert to the remote computing device while the remote computing device lights up and outputs haptic feedback.

145. The system of claim 143, wherein the doorbell is configured to i) enter or ii) exit, the non-auditory mode at i) a predetermined time of day, ii) a predetermined duration, or iii) by an input from a user.

146. The system of claim 127, wherein the doorbell is a first doorbell of a plurality of doorbells, the system further comprising at least a second doorbell,
wherein one or more doorbells of the plurality of doorbells are in the AP mode and one or more doorbells of the plurality of doorbells are in the vacancy mode, and
wherein the remote computing device of the user is configured to communicatively couple to a single doorbell of the plurality of doorbells, and wherein the master user has access to each all doorbells.
